(19) United States
(12) Patent Application Publication
(10) Pub. No.: US 2010/0332845 A1
(43) Pub. Date: Dec. 30, 2010

(54) INFORMATION PROCESSING SERVER, INFORMATION PROCESSING APPARATUS, AND INFORMATION PROCESSING METHOD

(75) Inventor: Kotaro Asaka, Tokyo (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: Sony Corporation, Minato-ku (JP)

(21) Appl. No.: 12/819,895

(22) Filed: Jun. 21, 2010

(30) Foreign Application Priority Data
Jun. 29, 2009 (JP) P2009-154005

(51) Int. Cl. G06F 12/14

(52) U.S. Cl. 713/189

(57) ABSTRACT

Methods and apparatuses for selectively performing at least one of encryption or decryption of data and for requesting a process. An information processing server includes a communication unit configured to receive from an information processing apparatus a processing request and a cryptographic key, and includes first and second storage units configured to temporarily store the received cryptographic key and to store data. The information processing server also includes a process determining unit configured to determine a type of process requested based on the processing request, and an encryption processing unit configured to selectively perform, based on the determined type of process requested, at least one of encryption or decryption on the stored data using the cryptographic key. The cryptographic key temporarily stored in the first storage unit is deleted after the at least one of encryption or decryption on the stored data has been selectively performed.

### CROSS-REFERENCE TO RELATED APPLICATIONS

The present application contains subject matter related to that disclosed in Japanese Priority Patent Application JP 2009-154005 filed in the Japan Patent Office on Jun. 29, 2009, the entire content of which is hereby incorporated by reference.

### BACKGROUND OF THE INVENTION

1. Field of the Invention

The present invention relates to an information processing server, an information processing apparatus, and an information processing method.

2. Description of the Related Art

In recent years, information processing apparatuses have been widely used that are capable of performing a process related to a service provided by a service providing server by communicating with the service providing server, which provides various services via a network. By causing such an information processing apparatus to perform communication related to services with one or more service providing servers via a network, a user of the information processing apparatus can enjoy the services provided by the service providing servers.

Under these circumstances, a technology for increasing convenience with which a service provided via a network is enjoyed has been developed. Japanese Unexamined Patent Application Publication No. 2003-271561 discloses an example of a technology for simplifying an authentication process by providing an authentication proxy server that performs an authentication process for one or more service providing servers that provide services.

### SUMMARY OF THE INVENTION

According to embodiments of the invention, there are provided an information processing server, method, and computer-readable storage medium for selectively performing at least one of encryption or decryption on data. The information processing server includes a communication unit, first and second storage units, a process determining unit, an encryption processing unit, and a cryptographic key control unit. The communication unit is configured to receive a processing request and a cryptographic key corresponding to the processing request from an information processing apparatus. The first storage unit is configured to temporarily store the cryptographic key received by the communication unit, and the second storage unit is configured to store data. The process determining unit is configured to determine a type of process requested based on the processing request. The encryption processing unit is configured to selectively perform, based on the determined type of process requested, at least one of encryption or decryption on the data stored in the second storage unit using the cryptographic key. Further, the cryptographic key control unit is configured to delete the cryptographic key temporarily stored in the first storage unit after the at least one of encryption or decryption on the data stored in the second storage unit has been selectively performed by the encryption processing unit.

Further, according to other embodiments of the present invention, there are provided an information processing apparatus, method, and computer-readable storage medium for requesting an information processing server to perform a process. The information processing apparatus includes a storage unit and a communication unit. The storage unit is configured to store at least one cryptographic key for at least one of encryption or decryption. Further, the communication unit is configured to send a processing request to an information processing server, and to send a stored cryptographic key corresponding to the processing request to the information processing server based on whether the processing request requires the information processing server to perform the at least one of encryption or decryption on data stored in the information processing server. The communication unit sends the stored cryptographic key to the information processing server when the processing request sent by the communication unit requires the information processing server to perform the at least one of encryption or decryption on the data stored in the information processing server.

According to other embodiments of the present invention, there is provided an information processing system, and a method thereof, including the above-described information processing server and information processing apparatus.

According to the embodiments of the present invention, abuse of a service can be prevented, and convenience with which a service provided via a network is enjoyed can be increased.

### BRIEF DESCRIPTION OF THE DRAWINGS

FIG. 1 illustrates an example of an information processing system according to an embodiment of the present invention;

FIG. 2 illustrates an example of information stored in an information processing apparatus according to the embodiment of the present invention;

FIG. 3 illustrates an example of information stored in the information processing apparatus according to the embodiment of the present invention;

FIG. 4 illustrates an example of information stored in an information processing server according to the embodiment of the present invention;

FIG. 5 illustrates an example of information stored in the information processing server according to the embodiment of the present invention;

FIG. 6 illustrates an example of information stored in the information processing server according to the embodiment of the present invention;

FIG. 7 illustrates a first example of a process related to an approach for increasing convenience according to the embodiment of the present invention;

FIG. 8 illustrates a second example of a process related to an approach for increasing convenience according to the embodiment of the present invention;

FIG. 9 is a flowchart illustrating an example of a reregistration process performed in the information processing server according to the embodiment of the present invention;

FIG. 10 is a flowchart illustrating an example of a campaign registration determination process performed in the information processing server according to the embodiment of the present invention;

FIG. 11 illustrates a third example of a process related to an approach for increasing convenience according to the embodiment of the present invention;

FIG. 12 illustrates a fourth example of a process related to an approach for increasing convenience according to the embodiment of the present invention;

FIG. 13 illustrates a fifth example of a process related to an approach for increasing convenience according to the embodiment of the present invention;

FIG. 14 illustrates a sixth example of a process related to an approach for increasing convenience according to the embodiment of the present invention;

FIG. 15 illustrates a seventh example of a process related to an approach for increasing convenience according to the embodiment of the present invention;

FIG. 16 illustrates an eighth example of a process related to an approach for increasing convenience according to the embodiment of the present invention;

FIG. 17 illustrates a ninth example of a process related to an approach for increasing convenience according to the embodiment of the present invention;

FIG. 18 illustrates an example of information stored in the information processing apparatus according to the embodiment of the present invention;

FIG. 19A is for explaining an example of a shift registration process performed in the information processing server according to the embodiment of the present invention;

FIG. 19B is for explaining an example of the shift registration process performed in the information processing server according to the embodiment of the present invention;

FIG. 20 illustrates a tenth example of a process related to an approach for increasing convenience according to the embodiment of the present invention;

FIG. 21A is for explaining an example of a process related to deletion of data about a portal user ID in the information processing server according to the embodiment of the present invention;

FIG. 21B is for explaining an example of a process related to deletion of data about a portal user ID in the information processing server according to the embodiment of the present invention;

FIG. 22 illustrates an example of a configuration of the information processing apparatus according to the embodiment of the present invention;

FIG. 23 illustrates an example of a hardware configuration of the information processing apparatus according to the embodiment of the present invention;

FIG. 24 illustrates an example of a configuration of the information processing server according to the embodiment of the present invention; and

FIG. 25 illustrates an example of a hardware configuration of the information processing server according to the embodiment of the present invention.

### DESCRIPTION OF THE PREFERRED EMBODIMENTS

Hereinafter, an exemplary embodiment of the present invention will be described in detail with reference to the attached drawings. In the specification and drawings, elements that have substantially the same functional configuration will be denoted by the same reference numerals and the corresponding description will be omitted.

The description will be given in the following order.

1. Approach according to the embodiment of the present invention
2. Information processing apparatus and information processing server according to the embodiment of the present invention
3. Program according to the embodiment of the present invention

### Approach According to the Embodiment of the Present Invention

Before describing configurations of an information processing apparatus and an information processing server according to the embodiment of the present invention (hereinafter referred to as “information processing apparatus 100” and “information processing server 200” in some cases, respectively), a description will be given about an approach for increasing convenience according to the embodiment of the present invention.

### Overview of Approach for Increasing Convenience According to The Embodiment of the Present Invention

As described above, convenience can be increased by causing an information processing server to collectively manage information for using (or accessing) a service provided by a service providing server (hereinafter referred to as “account information”), such as IDs and passwords. However, when there is a possibility of the collectively-managed account information being used by a malicious third party, as in the related art, abuse by the third party may Occur.

In the embodiment of the present invention, the information processing server 200 collectively manages account information that is encrypted with a cryptographic key associated with use of a service (hereinafter such a key is referred to as “service cryptographic key” and such account information is referred to as “encrypted account information”). Also, the information processing server 200 selectively encrypts account information and selectively decrypts encrypted account information on the basis of a processing request, service cryptographic key, and identification information that are transmitted from the information processing apparatus 100, and performs a process related to a service in response to the processing request.

Here, the processing request is an instruction to perform a process related to use of a service requested from an external apparatus, such as the information processing apparatus 100, transmitted to the information processing server 200. That is, the processing request indicates a process that is requested in order to use a service. Examples of the processing request include a registration request (initial registration request and reregistration request) and a usage start request (login request) described below.

The identification information is information (data) indicating an apparatus that has transmitted the processing request. The information processing server 200 specifies an external apparatus, such as the information processing apparatus 100, that has transmitted the processing request by using the identification information. Examples of the identification information include an integrated circuit card identifier (ICCID), which is an ID of a subscriber identity module (SIM), an international mobile equipment identifier (IMEI), which is an ID of an apparatus compatible with a third-generation mobile communication system, and a media access control (MAC) address.

More specifically, in the case of encrypting account information (e.g., in the case of receiving a registration request described below), the information processing server 200 encrypts the account information obtained from a service providing server by using a received service cryptographic key, for example. On the other hand, in the case of decrypting encrypted account information (e.g., in the case of receiving a usage start request described below), the information processing server 200 decrypts the encrypted account information that is associated with identification information by using a received service cryptographic key, thereby obtaining account information.

Here, the information processing server 200 stores a received service cryptographic key only temporarily (e.g., stores the key from the reception thereof until encryption/decryption is completed). Accordingly, even if encrypted account information that is collectively managed by the information processing server 200 is stolen by a malicious third party, it is difficult for the third party to decrypt the encrypted account information. Therefore, abuse of a service by the third party can be prevented in the embodiment of the present invention.

Also, in the embodiment of the present invention, since the information processing server 200 can collectively manage account information for enjoying a service provided by a service providing server, it is unnecessary for the information processing apparatus 100 to manage account information. Therefore, the convenience with which a service provided via a network is enjoyed can be increased in the embodiment of the present invention.

In the embodiment of the present invention, the above-described approach enables prevention of abuse of a service and increased convenience with which a service provided via a network is enjoyed.

### Example of Method for Encryption/Decryption with Service Cryptographic Key According to the Embodiment of the Present Invention

Now, a description will be given about an example of a method for encryption/decryption with a service cryptographic key according to the embodiment of the present invention. The information processing apparatus 100 and the information processing server 200 according to the embodiment of the present invention perform encryption/decryption of data with a service cryptographic key by using (A) shared key method, (B) public key method, and (C) shared key+public key method, for example.

Hereinafter, a description will be given about a case where a user of the information processing apparatus 100 inputs data of an account associated with a service (hereinafter referred to as “Ac”), but another case is also applicable. For example, the foregoing Ac may be Ac generated by a service providing server 400 or Ac generated by the information processing server 200 and transmitted therefrom to the information processing apparatus 100. Also, Ac can be encrypted by the information processing apparatus 100. Alternatively, the information processing server 200 may encrypt Ac generated by the service providing server 400 or Ac generated by the information processing server 200 by using a service cryptographic key transmitted from the information processing apparatus 100.

Hereinafter, a shared key is represented by “Sk”, a case of encrypting data (“data”) using a cryptographic key is represented by “E(key, data)”, and a case of decrypting data encrypted with a cryptographic key (“enc”) is represented by “D(key, enc)”. Also, a public key is represented by “PubK”, and a private key is represented by “PrvK”. Here, each of Sk, PubK, and PrvK plays a role of a service cryptographic key. Of course, Sk, PubK, and PrvK can function as separate cryptographic keys in units of services (accounts).

### (A) Shared Key Method

### (A-1) Encryption

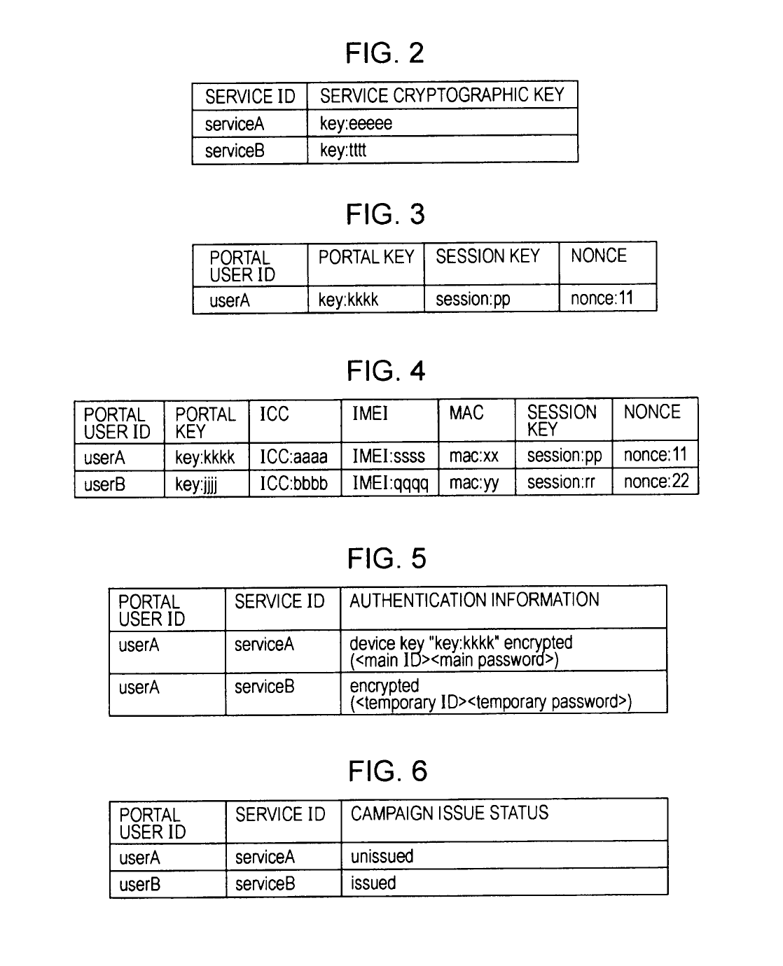

The information processing apparatus 100 generates Sk.
The information processing apparatus 100 stores Sk (e.g., FIG. 2 described below).
The information processing apparatus 100 performs E(Sk, Ac)=EncAc (the information processing apparatus 100 does not store EncAc).
The information processing apparatus 100 transmits EncAc to the information processing server 200.
The information processing server 200 stores EncAc (e.g., authentication information in FIG. 5 described below).

### (A-2) Decryption

The information processing apparatus 100 transmits Sk to the information processing server 200.
The information processing server 200 performs D(Sk, EncAc)=Ac.
The information processing server 200 deletes Sk.

### (B) Public Key Method

### (B-1) Encryption

The information processing apparatus 100 generates PubK and PrvK.
The information processing apparatus 100 stores PrvK.
The information processing apparatus 100 transmits PubK and Ac to the information processing server 200.
The information processing server 200 stores PubK.
The information processing server 200 performs E(PubK, Ac)=EncAc.
The information processing server 200 stores EncAc.

### (B-2) Decryption

The information processing apparatus 100 transmits Prvk to the information processing server 200.
The information processing server 200 performs D(Prvk, EncAc)=Ac.
The information processing server 200 deletes PrvK.

### (C) Shared Key+Public Key Method

### (C-1) Encryption

The information processing apparatus 100 generates PubK and PrvK.
The information processing apparatus 100 stores PubK and PrvK.
The information processing apparatus 100 generates Sk.
The information processing apparatus 100 performs E(Sk, Ac)=EncAc (the information processing apparatus 100 does not store EncAc).
The information processing apparatus 100 performs E(PubK, Sk)=EncSk (the information processing apparatus 100 does not store EncSk).
The information processing apparatus 100 transmits EncAc and EncSk to the information processing server 200.
The information processing server 200 stores EncAc and EncSk.

### (C-2) Decryption

The information processing server 200 transmits EncSk to the information processing apparatus 100.
The information processing apparatus 100 performs D(PrvK, EncSk)=Sk.
The information processing apparatus 100 transmits Sk to the information processing server 200.
The information processing server 200 performs D(Sk, EncAc)=Ac.
The information processing server 200 deletes Sk.

The information processing apparatus 100 and the information processing server 200 according to the embodiment of the present invention perform encryption/decryption of data with a service cryptographic key by using the foregoing methods (A) to (C), for example. The method according to the embodiment of the present invention is not limited to the foregoing methods (A) to (C). For example, in the method (A), the information processing server 200 may generate Sk and transmit the generated Sk to the information processing apparatus 100. Also, in the method (B), the information processing server 200 may generate PubK and PrvK. In that case, the information processing server 200 stores PubK and transmits PrvK to the information processing apparatus 100 without storing it. In the method (B), the information processing apparatus 100 may also store PubK, and may encrypt Ac and transmit EncAc to the information processing server 200. Furthermore, the information processing apparatus 100 and the information processing server 200 according to the embodiment of the present invention can apply an arbitrary method that is capable of realizing an approach for increasing convenience according to the embodiment of the present invention.

Hereinafter, a description will be given about a case where the information processing apparatus 100 and the information processing server 200 performs encryption/decryption of data by using the foregoing method (A) (the public key method).

### Example of Information Processing System According to the Embodiment of the Present Invention

Next, a description will be given about processes performed by the information processing apparatus 100 and the information processing server 200, respectively, with reference to an example of an information processing system according to the embodiment of the present invention.

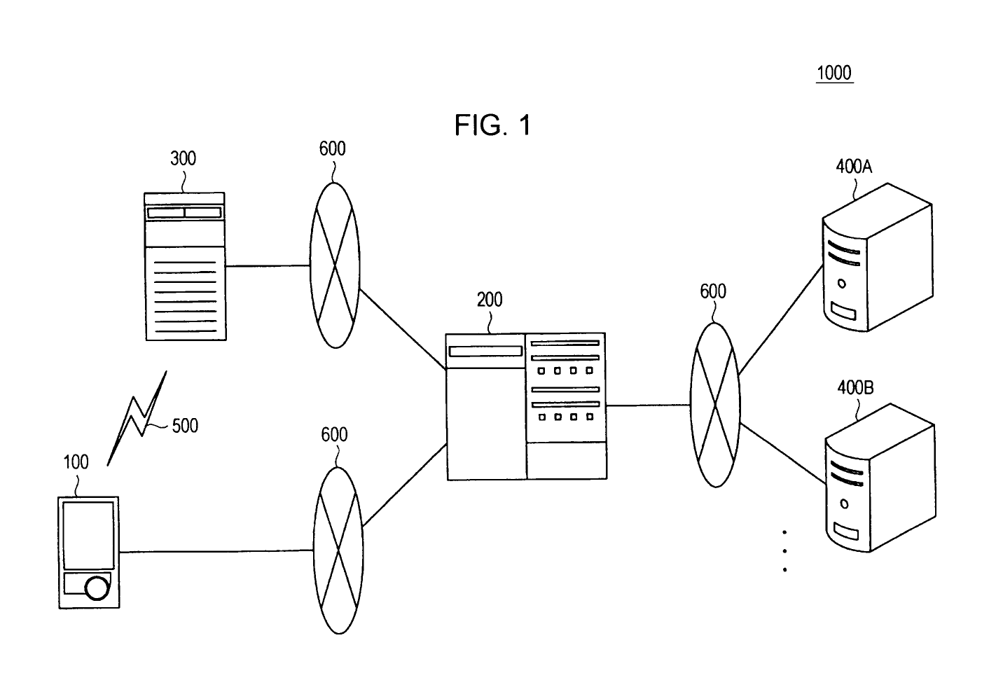

FIG. 1 illustrates an example of an information processing system 1000 according to the embodiment of the present invention. Here, FIG. 1 illustrates a configuration example in which attention is focused on one information processing apparatus 100, and other information processing apparatuses that can constitute the information processing system 1000 according to the embodiment of the present invention are omitted. Hereinafter, the one information processing apparatus 100 will be described. The other information processing apparatuses have the same function and configuration as those of the information processing apparatus 100, and thus the description thereof is omitted.

The information processing system 1000 includes the information processing apparatus 100, the information processing server 200, a communication management server 300, and service providing servers 400A, 400B, and the like (hereinafter collectively referred to as “service providing server 400” in some cases). The information processing apparatus 100 and the communication management server 300 are connected to each other via a wireless network 500 used in mobile communication, such as a third-generation (3G) network constituting a 3G mobile communication system, for example. Also, the information processing apparatus 100 and the information processing server 200, the information processing server 200 and the communication management server 300, and the information processing server 200 and the service providing server 400 are connected to each other via a network 600 (or directly), respectively. Here, “connection” according to the embodiment of the present invention means being in a state where communication can be performed (or bringing into a state where communication can be performed).

Examples of the network 600 include a wired network such as a local area network (LAN) or a wide area network (WAN), a wireless network such as a wireless wide area network (WWAN) or a wireless metropolitan area network (WMAN) via a base station, and the Internet using a communication protocol such as a transmission control protocol/Internet protocol (TCP/IP).

The information processing apparatus 100 is an apparatus that is owned by a user and that enjoys a service provided by the service providing server 400 via the network 600. Here, the information processing apparatus 100 illustrated in FIG. 1 functions as a video/audio reproducing apparatus (video/audio recording/reproducing apparatus), but the information processing apparatus 100 may function as another type of apparatus.

In the information processing system 1000, the information processing apparatus 100 can communicate with the information processing server 200 via the network 600, but another communication form is also available. For example, the information processing apparatus 100 may communicate with the communication management server 300 via the wireless network 500 for authentication. After the authentication has been normally completed in the communication management server 300, the information processing apparatus 100 can communicate with the information processing server 200 under communication control performed by the communication management server 300. In such a case where the information processing apparatus 100 and the information processing server 200 communicate with each other after the communication management server 300 authenticates the information processing apparatus 100, the possibility of identification information received by the information processing server 200 being tampered identification information can be decreased. In an example of a process in a processing request described below, descriptions will be separately given about cases where communication between the information processing apparatus 100 and the information processing server 200 is performed via the communication management server 300 and directly therebetween, but the process is not limited to the example described below.

### Overview of Processes Performed in the Information Processing Apparatus 100

The information processing apparatus 100 performs the following processes (i) and (ii).

### (i) Transmission of Various Pieces of Information

The information processing apparatus 100 transmits a processing request, a cryptographic key corresponding to a service indicated by the processing request (service cryptographic key), and identification information indicating the information processing apparatus 100 to the information processing server 200. Here, the information processing apparatus 100 transmits a generated service cryptographic key (e.g., in the case of transmitting a registration request) or a stored service cryptographic key (e.g., in the case of transmitting a usage start request) together with the processing request.

FIG. 2 illustrates an example of information stored in the information processing apparatus 100 according to the embodiment of the present invention. Here, FIG. 2 illustrates an example of a case where the information processing apparatus 100 stores service cryptographic keys of respective services while associating the keys with the services. Hereinafter, as illustrated in FIG. 2, the information that is stored in the information processing apparatus 100 and that includes service cryptographic keys associated with respective services is referred to as “apparatus-side service account information”.

The information processing apparatus 100 transmits a service cryptographic key corresponding to a service (indicated as a service ID in FIG. 2) requested in a processing request together with the processing request. For example, the information processing apparatus 100 records a generated service cryptographic key when having generated the service cryptographic key in accordance with a processing request to be transmitted, but another method is also applicable.

The information stored in the information processing apparatus 100 is not limited to the service cryptographic keys illustrated in FIG. 2. For example, the information processing apparatus 100 can also store the following information: an ID and a cryptographic key used for using the information processing server 200 (hereinafter referred to as “portal user ID” and “portal cryptographic key”, respectively); and a cryptographic key associated with communication with the information processing server 200 (hereinafter referred to as “session cryptographic key”).

FIG. 3 illustrates an example of information stored in the information processing apparatus 100 according to the embodiment of the present invention. Here, FIG. 3 illustrates an example in which the information processing apparatus 100 stores a portal user ID (the portal user ID in FIG. 3), a portal key, a session key, and a nonce (the nonce in FIG. 3). Hereinafter, as illustrated in FIG. 3, the information that is stored in the information processing apparatus 100 and that includes the portal user ID and the portal key associated with each other is referred to as “apparatus-side portal account information”.

### (ii) Execution of Process Based on Received Information

The information processing apparatus 100 performs a process on the basis of information transmitted from the information processing server 200 that has received the various pieces of information transmitted in the process (i). An example of the process (ii) includes a process related to a service between the information processing apparatus 100 and the service providing server 400 via the information processing server 200 (hereinafter referred to as “service process”). An example of the process performed by the information processing apparatus 100 in the process (ii) will be described in an example of the process in a processing example described below.

The information processing apparatus 100 can cause the information processing server 200 to perform a process in response to a processing request by performing the foregoing process (i). Also, by performing the process (ii), the information processing apparatus 100 can perform various processes related to a service on the basis of the information transmitted from the information processing server 200 in a process according to the processing request.

Accordingly, the user of the information processing apparatus 100 can enjoy a service provided by the service providing server 400 without managing account information for using the service provided by the service providing server 400 on the information processing apparatus 100 side.

The information processing server 200 collectively manages account information for enjoying services provided by the respective service providing servers 400 using the information processing apparatus 100, and performs a process based on a processing request that is transmitted from the information processing apparatus 100 and that indicates a process requested in order to use a service. Also, the information processing server 200 plays a role in relaying communication related to a service between the information processing apparatus 100 and the individual service providing servers 400.

More specifically, the information processing server 200 performs the following processes (I) to (III), for example, in accordance with reception of a processing request, service cryptographic key, and identification information transmitted from an external apparatus, such as the information processing apparatus 100. Hereinafter, a description will be given about a case where the information processing server 200 processes the processing request, service cryptographic key, and identification information transmitted by the information processing apparatus 100.

### (I) Storage of Service Cryptographic Key (Temporary Storage)

The information processing server 200 stores a received service cryptographic key. Here, the information processing server 200 stores the service cryptographic key in a volatile memory, such as a synchronous dynamic random access memory (SDRAM) or a static random access memory (SRAM), but the key may be stored in another type of memory. Also, the information processing server 200 deletes the stored service cryptographic key in the process (III) described below.

### (II) Determination of Requested Process

The information processing server 200 determines the type of process related to the service requested by the information processing apparatus 100 on the basis of the received processing request. More specifically, the information processing server 200 specifies the service and determines the type of process to be performed for the specified service on the basis of the processing request.

### (III) Execution of Process

The information processing server 200 performs a process in accordance with a determination result of the foregoing process (II). The information processing server 200 selectively performs, in accordance with a process to be performed, encryption/decryption of information (data), such as encryption of account information or decryption of encrypted account information that is collectively managed, using the service cryptographic key stored in the foregoing process (I).

Also, the information processing server 200 can identify an external apparatus that has transmitted a processing request on the basis of received identification information, and thus can specify the encrypted account information associated with the external apparatus.

Each of FIGS. 4 and 5 illustrates an example of information stored in the information processing server 200 according to the embodiment of the present invention.

Here, FIG. 4 illustrates an example of a case where the information processing server 200 stores identification information (ICCID, IMEI, and mac in FIG. 4), portal user IDs, portal keys, session keys, and nonces while associating them with each other. The information processing server 200 uses the information illustrated in FIG. 4 in order to determine whether the external apparatus that has transmitted the processing request is the apparatus serving as a processing target. Hereinafter, as illustrated in FIG. 4, the information used by the information processing server 200 to determine whether the external apparatus that has transmitted the processing request is the apparatus serving as a processing target is referred to as “portal account information”.

FIG. 5 illustrates an example of a case where the information processing server 200 stores portal user IDs, encrypted account information (authentication information in FIG. 5), and information indicating services to which accounts correspond (service IDs in FIG. 5) while associating them with each other. The information processing server 200 uses the information illustrated in FIG. 5 in the case of performing a process related to account information (e.g., encryption of account information or decryption of encrypted account information). Hereinafter, as illustrated in FIG. 5, the information used by the information processing server 200 to perform a process related to account information is referred to as “service account information”.

By storing information in the manner illustrated in FIGS. 4 and 5, the information processing server 200 can store identification information and encrypted account information by associating them with each other via portal user IDs. That is, the service account information according to the embodiment of the present invention may be defined as information including identification information and encrypted account information that are recorded while being associated with each other. The method for storing identification information and encrypted account information associated with each other in the information processing server 200 according to the embodiment of the present invention is not limited to the above-described method. For example, the information processing server 200 can store identification information and encrypted account information by directly associating them with each other.

The information stored in the information processing server 200 is not limited to the portal account information and service account information illustrated in FIGS. 4 and 5. For example, the information processing server 200 can also store information indicating whether each information processing apparatus can use an additional service provided by the service providing server 400.

FIG. 6 illustrates an example of information stored in the information processing server 200 according to the embodiment of the present invention. Here, FIG. 6 illustrates an example where the information processing server 200 stores information indicating whether an additional service can be used (campaign issue status in FIG. 6), portal user IDs, and information indicating services corresponding to the additional service (service IDs in FIG. 6) while associating them with each other.

Additionally, the information indicating whether an additional service can be used illustrated in FIG. 6 is stored while being associated with identification information via a portal user ID. That is, the information illustrated in FIG. 6 can be defined as information including identification information and information indicating whether an additional service can be used that are recorded while being associated with each other. Hereinafter, as illustrated in FIG. 6, for example, information including identification information and information indicating whether an additional service can be used that are recorded while being associated with each other is referred to as “additional service management information”. The additional service management information according to the embodiment of the present invention is not limited to the example illustrated in FIG. 6. For example, the information processing server 200 can store identification information and information indicating whether an additional service can be used while directly associating them with each other.

After encryption/decryption of information has been completed, the information processing server 200 deletes the service cryptographic key stored in the foregoing process (I). By intentionally deleting the service cryptographic key stored in the foregoing process (I), the information processing server 200 prevents the occurrence of abuse of a service by a third party.

By performing the foregoing processes (I) to (III), the information processing server 200 realizes prevention of abuse of a service and increased convenience with which a user of the information processing apparatus 100 enjoys a service via a network. Examples of a process performed in the information processing server 200 in response to a processing request will be described below.

The communication management server 300 authenticates the information processing apparatus 100 and selectively causes the information processing apparatus 100 and the information processing server 200 to be connected to each other in accordance with an authentication result. At this time, the communication management server 300 can cause the information processing apparatus 100 and the information processing server 200 to be connected to each other via a secure communication channel, such as a virtual private network (VPN). Here, a server managed by a telecommunications carrier is used as the communication management server 300, but another type of server may also be used.

After the communication management server 300 has performed authentication and has caused the information processing apparatus 100 and the information processing server 200 to be connected to each other, the information processing server 200 can perform a process by using identification information that has been ensured not to be tampered.

The individual service providing servers 400 provide (manage) various services to be provided via the network 600, e.g., distribute various types of content, such as video content and audio content.

The information processing system 1000 includes the above-described information processing apparatus 100, information processing server 200, communication management server 300, and service providing servers 400. With the above-described configuration, the information processing system 1000 realizes the approach for increasing convenience according to the embodiment of the present invention.

### Specific Examples of Process Related to Approach for Increasing Convenience

Hereinafter, a description will be given about examples of a process related to an approach for increasing convenience according to the embodiment of the present invention in units of processing requests transmitted by the information processing apparatus 100, using the information processing system 1000 illustrated in FIG. 1 as an example. Hereinafter, a description will be given about cases where communication between the information processing apparatus 100 and the information processing server 200 is performed via the communication management server 300 and directly therebetween, but the embodiment of the present invention is not limited to the following example. For example, the information processing apparatus 100 and the information processing server 200 can communicate with each other directly via the network 600, or via the communication management server 300, regardless of the type of processing request.

### (1) Initial Registration Request (Registration Request)

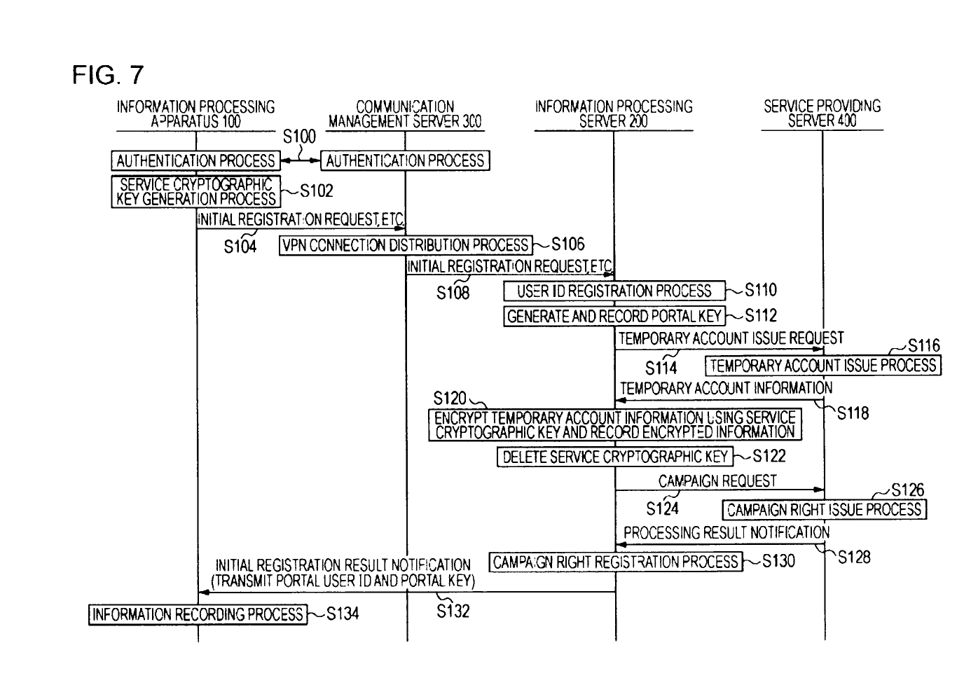

FIG. 7 illustrates a first example of a process related to an approach for increasing convenience according to the embodiment of the present invention. Here, FIG. 7 illustrates an example of a process performed in a case where the information processing apparatus 100 transmits an initial registration request, which is a registration request for starting use of the information processing server 200 and use of a service.

The information processing apparatus 100 communicates with the communication management server 300 via the wireless network 500, so that the information processing apparatus 100 and the communication management server 300 perform an authentication process (step S100). Here, the communication management server 300 performs, as the authentication process, user authentication of the information processing apparatus 100, position management of the information processing apparatus 100, management of subscriber information (in a case of carrier), management of a session, and NW registration of the information processing apparatus 100, but the authentication process is not limited to those described above.

In a case where the information processing apparatus 100 is not authenticated by the communication management server 300 in step S100, the communication management server 300 does not connect the information processing apparatus 100 and the information processing server 200 to each other in step S106 described below. Hereinafter, a description will be given under the assumption that authentication process is normally performed in step S100.

After the authentication process is performed in step S100, the information processing apparatus 100 generates a service cryptographic key (step S102: service cryptographic key generation process). Also, the information processing apparatus 100 stores the service cryptographic key generated in step S102 in the form illustrated in FIG. 2, for example. Alternatively, another storage form may be applied. Then, the information processing apparatus 100 transmits an initial registration request, identification information, and the service cryptographic key to the communication management server 300 (step S104).

Here, step S104 in FIG. 7 indicates that the information processing apparatus 100 transmits an initial registration request to the communication management server 300, and transmission of identification information and the service cryptographic key is not illustrated. Hereinafter, examples of a process related to an approach for increasing convenience will be described with reference to figures similar to FIG. 7. In those figures illustrating examples of a process related to an approach for increasing convenience described below, the identification information and service cryptographic key that are transmitted together with a processing request are not illustrated as in step S104 in FIG. 7.

The communication management server 300 that has received the initial registration request transmitted in step S104 performs distribution to VPN connection based on a URL or the like (step S106), and transmits the initial registration request, identification information, and service cryptographic key to the information processing server 200 (step S108).

The information processing server 200 that has received the initial registration request, identification information, and service cryptographic key transmitted in step S108 determines the type of the received processing request, that is, determines that the received processing request is an initial registration request (not illustrated). Then, the information processing server 200 starts a process in accordance with the determined processing request. Additionally, the information processing server 200 determines the type of a received processing request and starts a process in accordance with the determined processing request also in the examples of a process related to an approach for increasing convenience described below, but a description about the determination of the type of the received processing request is omitted.

Also, the information processing server 200 that has received the service cryptographic key transmitted in step S108 records the service cryptographic key in a first storage unit described below (not illustrated). The information processing server 200 records the received service cryptographic key in the first storage unit also in the following examples of a process related to an approach for increasing convenience, but the description thereof is omitted.

The information processing server 200 registers a portal user ID on the basis of the identification information received in step S108 (step S110: user ID registration process), and also generates and records a portal key (step S112). Here, the information processing server 200 stores the portal user ID and the portal key in the form illustrated in FIG. 4 in steps S110 and S112, but another form may also be applied.

The information processing server 200 transmits, to the service providing server 400 that provides a service related to the initial registration request on the basis of the initial registration request, a temporary account issue request for requesting issue of a temporary account (step S114). Here, FIG. 7 illustrates an example in which the information processing server 200 transmits a temporary account issue request in order to use a service provided by the service providing server 400 as a temporary user (e.g., a user who temporarily uses a service), but of course another example may also be applied.

The service providing server 400 that has received the temporary account issue request transmitted from the information processing server 200 in step S114 issues a temporary account (step S116: temporary account issue process). Then, the service providing server 400 transmits temporary account information (an example of account information), which is information about a temporary account for using a service, to the information processing server 200 (step S118). Here, examples of the temporary account information include a temporary user ID and a temporary password for using a service.

The information processing server 200 that has received the temporary account information transmitted from the service providing server 400 in step S118 encrypts the temporary account information using the service cryptographic key stored in the first storage unit and records the encrypted temporary account information (step S120). Here, in step S120, the information processing server 200 stores the encrypted temporary account information (an example of encrypted account information) in the form of being associated with the identification information illustrated in FIG. 4 via a portal user ID, as illustrated in FIG. 5, for example. Alternatively, another storage form may be used.

After completing step S120, the information processing server 200 deletes the service cryptographic key stored in the first storage unit (step S122). Step S122 causes the information processing server 200 to be incapable of decrypting the encrypted account information by itself. Therefore, even if the information illustrated in FIGS. 4 and 5 is stolen by a third party, abuse of a service by the third party can be prevented.

The information processing server 200 transmits a campaign request to the service providing server 400 to which the temporary account issue request was transmitted in step S114 (step S124). Here, the campaign request is an example of an instruction for requesting use of an additional service to the service providing server 400 from the information processing server 200. Here, although not illustrated in FIG. 7, the information processing server 200 is capable of determining whether the information processing apparatus 100 has already used an additional service on the basis of the additional service management information illustrated in FIG. 6 and selectively performing step S124 in accordance with a determination result. An example of a determination process related to selective execution of step S124 will be described below with reference to FIG. 10.

The service providing server 400 that has received the campaign request transmitted from the information processing server 200 in step S124 performs a process of issuing a right with which the information processing apparatus 100 can use a campaign (an example of additional service) in step S126 (campaign right issue process). Then, the service providing server 400 transmits a processing result notification indicating a result of step S126 to the information processing server 200 (step S128). Here, examples of the processing result notification transmitted in step S128 include a campaign registration completion notification indicating that issue of the right has been completed and an error notification indicating that issue of the right has not been completed. The service providing server 400 transmits the error notification in a case where an error occurs during a process or where the information processing apparatus 100 is an information processing apparatus that is incapable of using the right.

The information processing server 200 that has received the processing result notification transmitted in step S128 performs a process in accordance with the processing result. For example, when receiving a campaign registration completion notification, the information processing server 200 registers information indicating that the information processing apparatus 100 has obtained the right to use the campaign (step S130: campaign right registration process). Here, when receiving the campaign registration completion notification, the information processing server 200 performs step S130 by updating the campaign issue status illustrated in FIG. 6 from “unissued” to “issued”, but step S130 may be performed in another manner.

After completing step S130, the information processing server 200 transmits an initial registration result notification, indicating the result of the process performed in response to the initial registration request, to the information processing apparatus 100 (step S132). In a case where the process performed in response to the initial registration request has been normally completed, the information processing server 200 transmits the portal user ID and portal key together with the initial registration result notification.

The information processing apparatus 100 that has received the initial registration result notification transmitted from the information processing server 200 in step S132 stores the portal user ID and portal key that have been transmitted together with the initial registration result notification, indicating that the process has been normally completed (step S134: information recording process). Here, the information processing apparatus 100 stores the received portal user ID and portal key in the form illustrated in FIG. 3, but another storage form may also be used.

In a case where the information processing apparatus 100 transmits an initial registration request, the process illustrated in FIG. 7 is performed in the information processing system 1000, for example. Of course, the process performed in a case where the information processing apparatus 100 transmits an initial registration request according to the embodiment of the present invention is not limited to the process illustrated in FIG. 7.

### (2) First Example of Portal Key Reissue Request

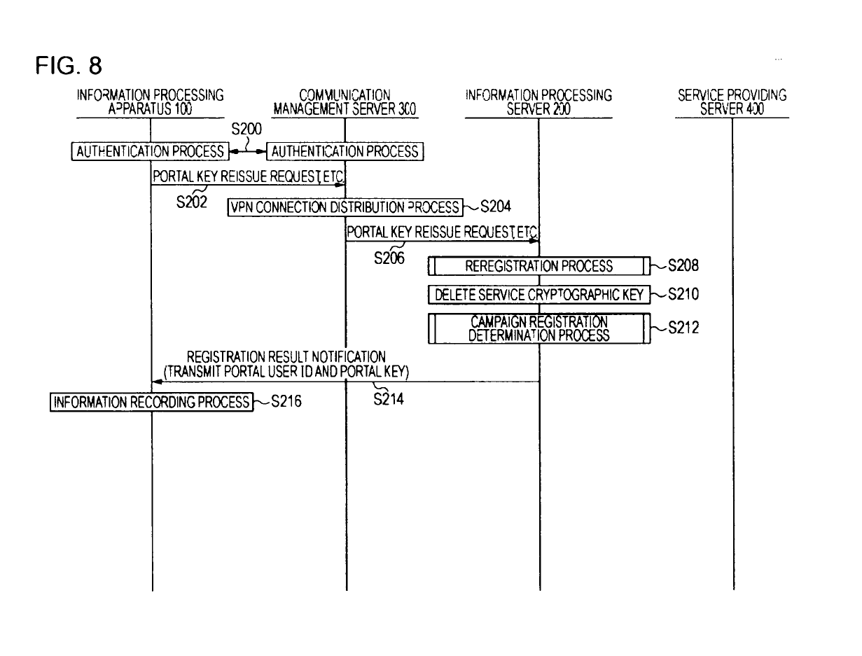

FIG. 8 illustrates a second example of a process related to an approach for increasing convenience according to the embodiment of the present invention. Here, FIG. 8 illustrates an example of a process performed in a case where the information processing apparatus 100 requests reissue of the portal key for using the information processing server 200 when the information processing apparatus 100 loses the portal key due to reset of the apparatus, for example.

As in step S100 in FIG. 7, the information processing apparatus 100 communicates with the communication management server 300 via the wireless network 500, so that the information processing apparatus 100 and the communication management server 300 perform an authentication process (step S200).

The information processing apparatus 100 transmits a portal key reissue request, identification information, and a service cryptographic key to the communication management server 300 (step S202). Here, in step S202, the information processing apparatus 100 transmits any of the service cryptographic keys stored in the manner illustrated in FIG. 2, for example.

The communication management server 300 that has received the portal key reissue request transmitted in step S202 performs distribution to VPN connection based on a URL or the like, as in step S106 in FIG. 7 (step S204). Then, the communication management server 300 transmits the portal key reissue request, identification information, and service cryptographic key to the information processing server 200 (step S206).

The information processing server 200 that has received the portal key reissue request transmitted in step S206 performs a reregistration process in response to the portal key reissue request (step S208).

### Example of Reregistration Process

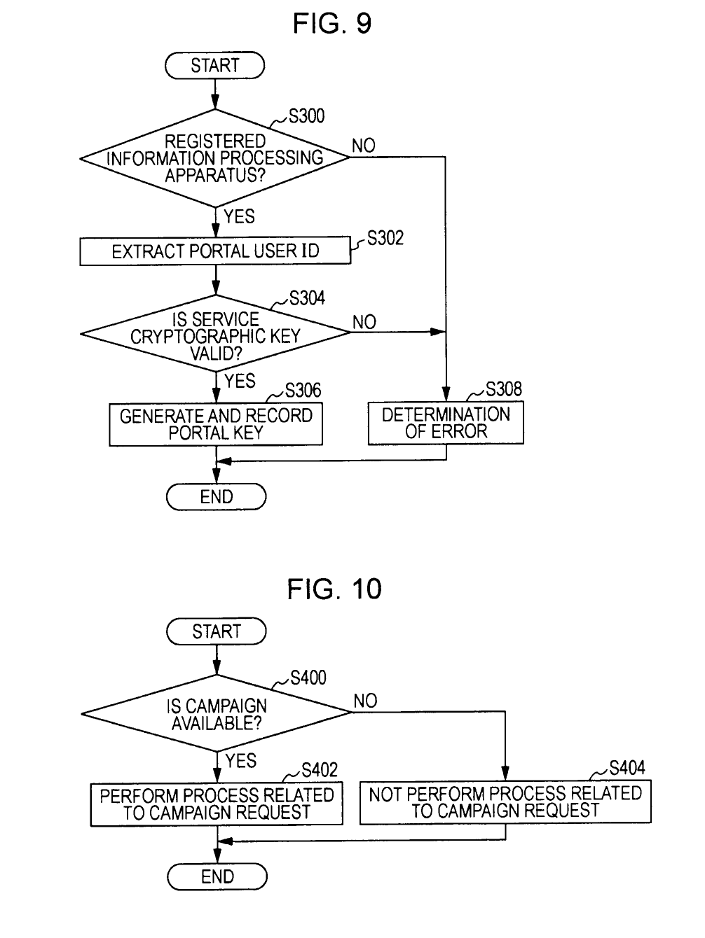

FIG. 9 is a flowchart illustrating an example of the reregistration process performed in the information processing server 200 according to the embodiment of the present invention.

The information processing server 200 determines whether the information processing apparatus 100 that has transmitted the reregistration request has been registered (step S300). Here, the information processing server 200 determines that the information processing apparatus 100 has been registered when there is a portal user ID corresponding to the received identification information on the basis of the identification information and the portal account information (e.g., FIG. 4). Alternatively, the determination may be performed in another manner.

In a case where the information processing server 200 determines in step S300 that the information processing apparatus 100 is not a registered apparatus, the information processing server 200 makes a determination of an error (step S308), and ends the reregistration process without generating a portal key. In that case, the information processing server 200 does not perform step S212 in FIG. 8 described below.

In a case where the information processing server 200 determines in step S300 that the information processing apparatus 100 is a registered apparatus, the information processing server 200 extracts the portal user ID from the portal account information (step S302). Then, the information processing server 200 determines the validity of the service cryptographic key on the basis of the service cryptographic key stored in the first storage unit (i.e., the received service cryptographic key), the service account information, and the portal user ID (step S304). Here, the information processing server 200 determines that the service cryptographic key is valid when the encrypted account information (e.g., FIG. 5) corresponding to the portal user ID in the service account information can be decrypted with the service cryptographic key, but the determination may be performed in another manner.

In a case where the information processing server 200 determines in step S304 that the service cryptographic key is not valid, the information processing server 200 makes a determination of an error (step S308), and ends the reregistration process without generating a portal key.

In a case where the information processing server 200 determines in step S304 that the service cryptographic key is valid, the information processing server 200 generates and records a portal key, as in step S112 in FIG. 7 (step S306).

The information processing server 200 realizes the reregistration process by performing the process illustrated in FIG. 9, for example. Of course, the reregistration process according to the embodiment of the present invention is not limited to the process illustrated in FIG. 9.

Referring back to FIG. 8, a description will be further given about the second example of a process related to an approach for increasing convenience. After the reregistration process in step S208 has ended, the information processing server 200 deletes the service cryptographic key stored in the first storage unit, as in step S122 in FIG. 7 (step S210).

Also, the information processing server 200 selectively performs a campaign registration determination process in accordance with the result of step S208 (step S212). Here, the campaign registration determination process illustrated in FIG. 8 is an example of a process of determining whether the information processing apparatus 100 can use an additional service.

### Example of Campaign Registration Determination Process

FIG. 10 is a flowchart illustrating an example of the campaign registration determination process performed in the information processing server 200 according to the embodiment of the present invention.

The information processing server 200 determines whether a campaign (an example of an additional service) is available (step S400). Here, in a case where there is a service with “unissued”, the information processing server 200 determines that a campaign for the service is available on the basis of the portal user ID and the additional service management information (e.g., FIG. 6). Alternatively, the determination may be performed in another manner.

In a case where the information processing server 200 determines in step S400 that a campaign is available, the information processing server 200 performs a process related to a campaign request (e.g., steps 5124 to 5130 in FIG. 7) with the service providing server 400 (step S402).

In a case where the information processing server 200 determines in step S400 that a campaign is not available, the information processing server 200 does not perform a process related to the campaign request (step S404) and ends the campaign registration determination process.

The information processing server 200 realizes the campaign registration determination process by performing the process illustrated in FIG. 10, for example. Of course, the campaign registration determination process according to the embodiment of the present invention is not limited to the process illustrated in FIG. 10.

Referring back to FIG. 8, a description will be further given about the second example of a process related to an approach for increasing convenience. The information processing server 200 transmits a registration result notification indicating the result of the process performed in response to the portal key reissue request to the information processing apparatus 100 (step S214). In a case where the process performed in response to the portal key reissue request has been normally completed, the information processing server 200 transmits the portal user ID and portal key together with the registration result notification.

The information processing apparatus 100 that has received the registration result notification transmitted from the information processing server 200 in step S214 stores the portal user ID and portal key transmitted together with the registration result notification indicating that the process has been normally completed, as in step S134 in FIG. 7 (step S216).

In a case where the information processing apparatus 100 transmits a portal key reissue request, the process illustrated in FIG. 8 is performed in the information processing system 1000. Of course, the process that is performed in a case where the information processing apparatus 100 transmits a portal key reissue request according to the embodiment of the present invention is not limited to the process illustrated in FIG. 8.

### (3) First Example of Login Request to Information Processing Server 200

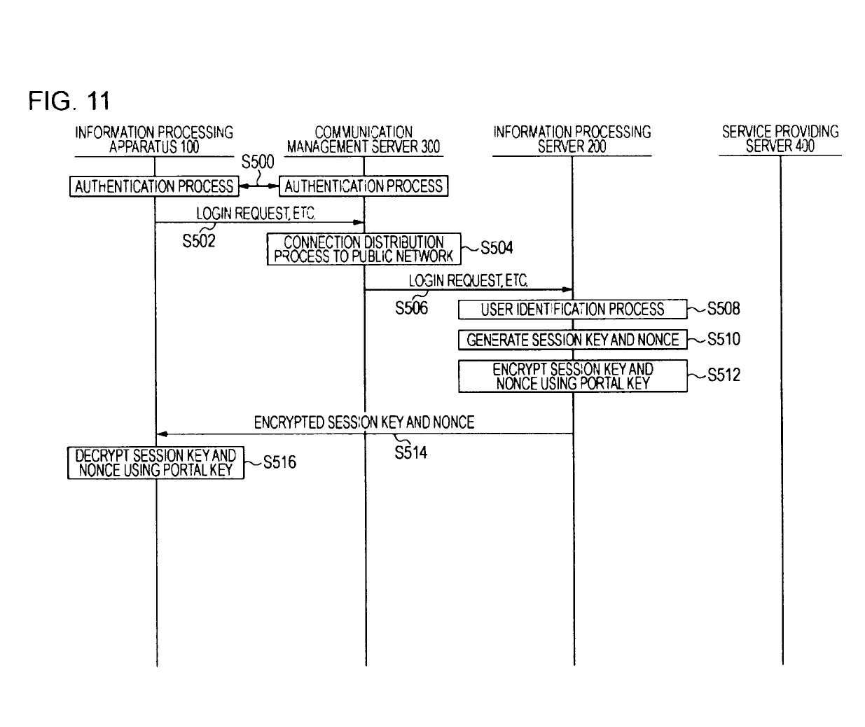

FIG. 11 illustrates a third example of a process related to an approach for increasing convenience according to the embodiment of the present invention. Here, FIG. 11 illustrates an example of a process that is performed in a case where the information processing apparatus 100 logs into the information processing server 200 via the communication management server 300.

As in step S100 in FIG. 7, the information processing apparatus 100 communicates with the communication management server 300 via the wireless network 500, so that the information processing apparatus 100 and the communication management server 300 perform an authentication process (step S500).

The information processing apparatus 100 transmits a login request, identification information, and a portal user ID to the communication management server 300 (step S502). Here, the information processing apparatus 100 transmits the portal user ID stored in the manner illustrated in FIG. 3 in step S502.

The communication management server 300 that has received the login request transmitted in step S502 performs connection distribution to a public network, such as the Internet, on the basis of a URL or the like (step S504). Also, the communication management server 300 transmits the login request, identification information, and portal user ID to the information processing server 200 (step S506).

The information processing server 200 that has received the login request transmitted in step S506 performs a user identification process in response to the login request (step S508). Here, the information processing server 200 determines in step S508 whether the portal user ID that satisfies the received identification information and portal user ID is recorded in the portal account information, but the process performed in step S508 is not limited to the foregoing process. In a case where the portal user ID is not recorded in the portal account information, the information processing server 200 transmits an error notification to the information processing apparatus 100 without performing steps S510 and 5512 described below.

After the user identification process in step S508 has been normally completed, the information processing server 200 generates a session key and a nonce (step S510). Then, the information processing server 200 records the generated session key and nonce in the portal account information (e.g., FIG. 4). Here, the session key and nonce recorded in the portal account information are stored for a predetermined period defined in advance and are deleted after the predetermined period has elapsed from the recording. Alternatively, another method may also be used.

The information processing server 200 encrypts the generated session key and nonce by using the portal key corresponding to the portal user ID that was authenticated in step S508 (step S512) and transmits the encrypted session key and nonce to the information processing apparatus 100 (step S514).

The information processing apparatus 100 that has received the encrypted session key and nonce transmitted from the information processing server 200 in step S514 decrypts the encrypted session key and nonce by using the portal key that is stored in the manner illustrated in FIG. 3, for example (step S516). Then, the information processing apparatus 100 records the decrypted session key and nonce in the apparatus-side portal account information (e.g., FIG. 3). Here, the session key and nonce recorded in the apparatus-side portal account information are stored for a predetermined period defined in advance and are deleted after the predetermined period has elapsed from the recording. Alternatively, another method may also be used.

In a case where the information processing apparatus 100 transmits a login request to the communication management server 300, the process illustrated in FIG. 11 is performed in the information processing system 1000. For example, by performing the process illustrated in FIG. 11, a communication channel used for communication related to a service performed thereafter between the information processing apparatus 100 and the information processing server 200 can be encrypted, so that the security level of the communication can be increased. Of course, the process performed in a case where the information processing apparatus 100 transmits a login request to the communication management server 300 according to the embodiment of the present invention is not limited to the process illustrated in FIG. 11. Additionally, in a case where the process related to the login request illustrated in FIG. 11 has been normally completed, another process is performed, for example, a process related to a service login request (usage start request) described below.

### (4) Second Example of Login Request to Information Processing Server 200

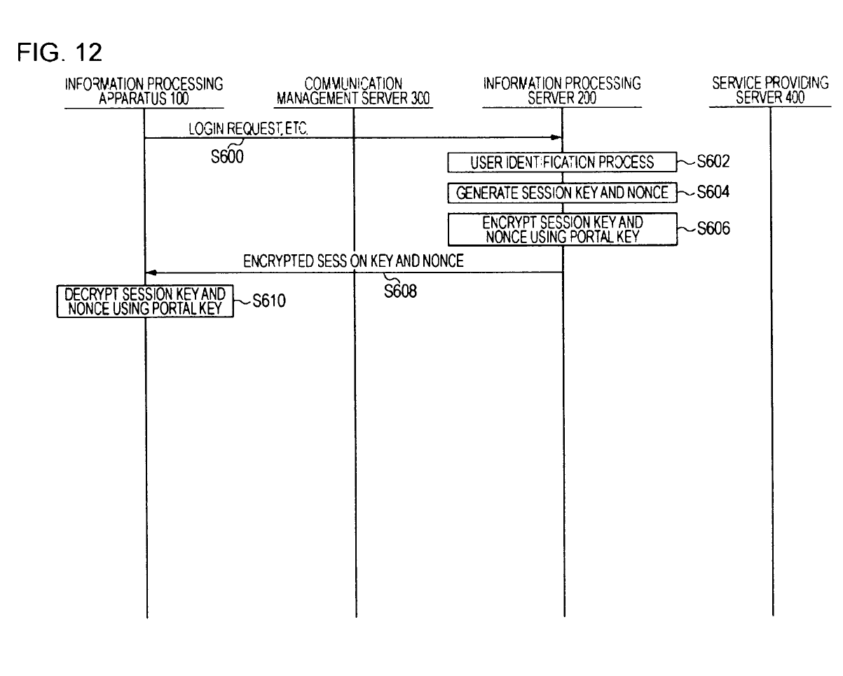

FIG. 12 illustrates a fourth example of a process related to an approach for increasing convenience according to the embodiment of the present invention. Here, FIG. 12 illustrates an example of a process that is performed in a case where the information processing apparatus 100 logs into the information processing server 200 via the communication management server 300.

The information processing apparatus 100 transmits a login request, identification information, and a portal user ID to the information processing server 200 via the network 600 (step S600). Here, the information processing apparatus 100 transmits the portal user ID stored in the manner illustrated in FIG. 3 in step S600.

The information processing server 200 that has received the login request transmitted in step S600 performs a user identification process in response to the login request, as in step S508 in FIG. 11 (step S602).

After the user identification process in step S602 has been normally completed, the information processing server 200 generates a session key and a nonce, as in step S510 in FIG. 11 (step S604). Then, the information processing server 200 records the generated session key and nonce in the portal account information (e.g., FIG. 4).

Then, as in step S512 in FIG. 11, the information processing server 200 encrypts the generated session key and nonce by using the portal key corresponding to the portal user ID authenticated in step S602 (step S606). Then, the information processing server 200 transmits the encrypted session key and nonce to the information processing apparatus 100 (step S608).

The information processing apparatus 100 that has received the encrypted session key and nonce transmitted from the information processing server 200 in step S608 decrypts the encrypted session key and nonce by using the portal key, as in step S516 in FIG. 11 (step S610). Then, the information processing apparatus 100 records the decrypted session key and nonce in the apparatus-side portal account information (e.g., FIG. 3).

In a case where the information processing apparatus 100 transmits a login request to the information processing server 200, the process illustrated in FIG. 12 is performed in the information processing system 1000. For example, by performing the process illustrated in FIG. 12, a communication channel used for communication related to a service performed thereafter between the information processing apparatus 100 and the information processing server 200 can be encrypted, so that the security level of the communication can be increased. Of course, the process performed in a case where the information processing apparatus 100 transmits a login request to the information processing server 200 according to the embodiment of the present invention is not limited to the process illustrated in FIG. 12. Additionally, in a case where the process related to the login request illustrated in FIG. 12 has been normally completed, another process is performed, for example, a process related to a service login request (usage start request) described below.

### (5) Service Account Registration Request

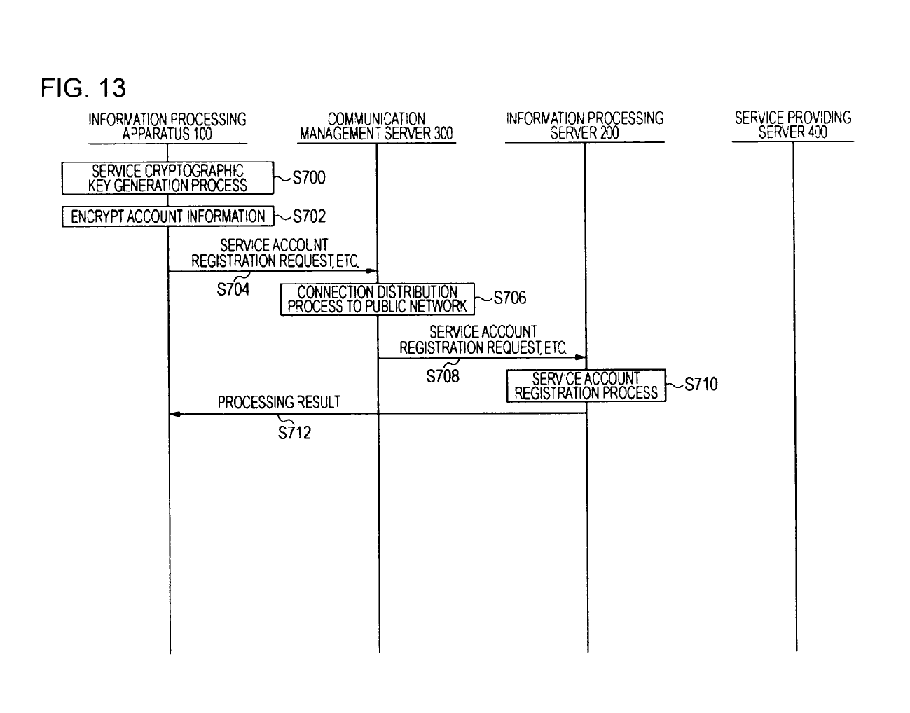

FIG. 13 illustrates a fifth example of a process related to an approach for increasing convenience according to the embodiment of the present invention. Here, FIG. 13 illustrates an example of a process performed in a case where the information processing apparatus 100 requests registration of service account information input by a user, for example. In FIG. 13, it is assumed that a communication channel used for communication between the information processing apparatus 100 and the information processing server 200 is encrypted with a session key that is shared through the login process illustrated in FIGS. 11 and 12, and a description about a process related to the encryption is omitted.

As in step S102 in FIG. 7, the information processing apparatus 100 generates and stores a service cryptographic key (step S700) and encrypts account information by using the generated cryptographic key (step S702). Then, the information processing apparatus 100 transmits a service account registration request, identification information, and the encrypted account information to the communication management server 300 (step S704).

As in step S504 in FIG. 11, the communication management server 300 that has received the service account registration request transmitted in step S704 performs connection distribution to a public network, such as the Internet, on the basis of a URL or the like (step S706). Then, the communication management server 300 transmits the service account registration request, identification information, and encrypted account information to the information processing server 200 (step S708).

The information processing server 200 that has received the service account registration request transmitted in step S708 performs a service account registration process in response to the service account registration request (step S710). In step S710, the information processing server 200 records the portal user ID corresponding to the identification information, the service ID included in the service account registration request, and the encrypted account information in the service account information illustrated in FIG. 5 while associating them with each other, but the process performed in step S710 is not limited to the foregoing process.

After step S710, the information processing server 200 transmits a processing result of step S710 to the information processing apparatus 100 (step S712).

In a case where the information processing apparatus 100 transmits a service account registration request, the process illustrated in FIG. 13 is performed in the information processing system 1000. Of course, the process performed in a case where the information processing apparatus 100 transmits a service account registration request according to the embodiment of the present invention is not limited to the process illustrated in FIG. 13.

### (6) Service Login Request (Usage Start Request)

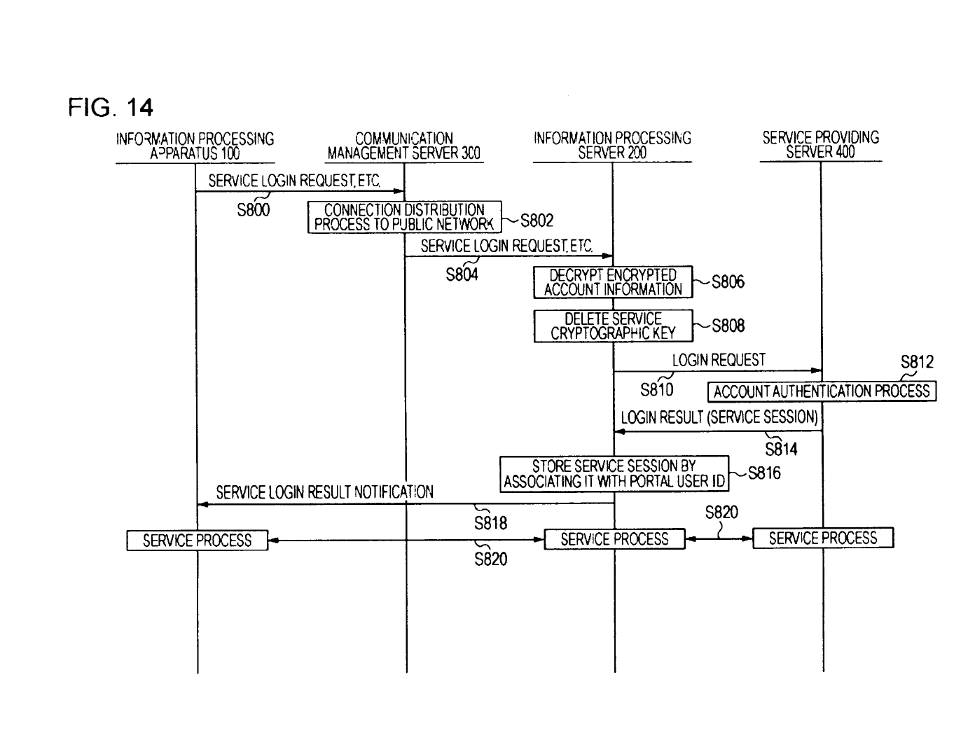

FIG. 14 illustrates a sixth example of a process related to an approach for increasing convenience according to the embodiment of the present invention. Here, FIG. 14 illustrates an example of a process performed in a case where the information processing apparatus 100 requests start of using a service. In FIG. 14, it is assumed that a communication channel used for communication between the information processing apparatus 100 and the information processing server 200 is encrypted with a session key that is shared through the login process illustrated in FIGS. 11 and 12, and a description about a process related to the encryption will be omitted.

The information processing apparatus 100 transmits a service login request, identification information, and a service cryptographic key to the communication management server 300 (step S800).

The communication management server 300 that has received the service login request transmitted in step S800 performs, as in step S504 in FIG. 11, connection distribution to a public network, such as the Internet, on the basis of a URL or the like (step S802). Then, the communication management server 300 transmits the service login request, identification information, and service cryptographic key to the information processing server 200 (step S804).

The information processing server 200 that has received the service login request transmitted in step S804 decrypts encrypted account information associated with the received identification information included in the service account information (e.g., FIG. 5) in response to the service login request (step S806). Here, the information processing server 200 decrypts the encrypted account information by using the service cryptographic key (received service cryptographic key) stored in the first storage unit. By performing step S806, the information processing server 200 can obtain account information for causing the service providing server 400 to be in a state where a service is available.

After decryption of the encrypted account information in step S806 has been completed, the information processing server 200 deletes the service cryptographic key stored in the first storage unit, as in step S122 in FIG. 7 (step S808).

Then, the information processing server 200 transmits a login request and the account information obtained in step S806 to the service providing server 400 that provides a service corresponding to the account information by using the account information (step S810).

The service providing server 400 performs account authentication on the basis of the account information transmitted from the information processing server 200 in step S810 (step S812) and transmits a login result to the information processing server 200 (step S814). Here, in a case where authentication is normally performed in step S812, the service providing server 400 also transmits a service session in step S814.

In a case where a service session is transmitted from the service providing server 400 in step S814, the information processing server 200 stores the service session by associating it with the portal user ID (step S816). Here, the service session is used for encrypting the communication channel between the information processing server 200 and the service providing server 400, for example. Then, the information processing server 200 transmits a service login result notification indicating a result of the process performed in response to the service login request to the information processing apparatus 100 (step S818).

In a case where the service login result notification transmitted in step S818 indicates success in login, the information processing apparatus 100 is in a state of being capable of using a service provided by the service providing server 400. In that case, communication related to a service is performed between the information processing apparatus 100 and the information processing server 200, and also communication related to the service is performed between the information processing server 200 and the service providing server 400 (step S820). That is, the information processing server 200 plays a role in relaying communication related to the service between the information processing apparatus 100 and the service providing server 400.

Accordingly, the information processing apparatus 100 can use a service provided by the service providing server 400 via the information processing server 200, so that the user of the information processing apparatus 100 can enjoy the service provided by the service providing server 400.

In a case where the information processing apparatus 100 transmits a service login request, the process illustrated in FIG. 14 is performed in the information processing system 1000. Of course, the process that is performed in a case where the information processing apparatus 100 transmits a service login request according to the embodiment of the present invention is not limited to the process illustrated in FIG. 14.

### (7) Second Example of Portal Key Reissue Request

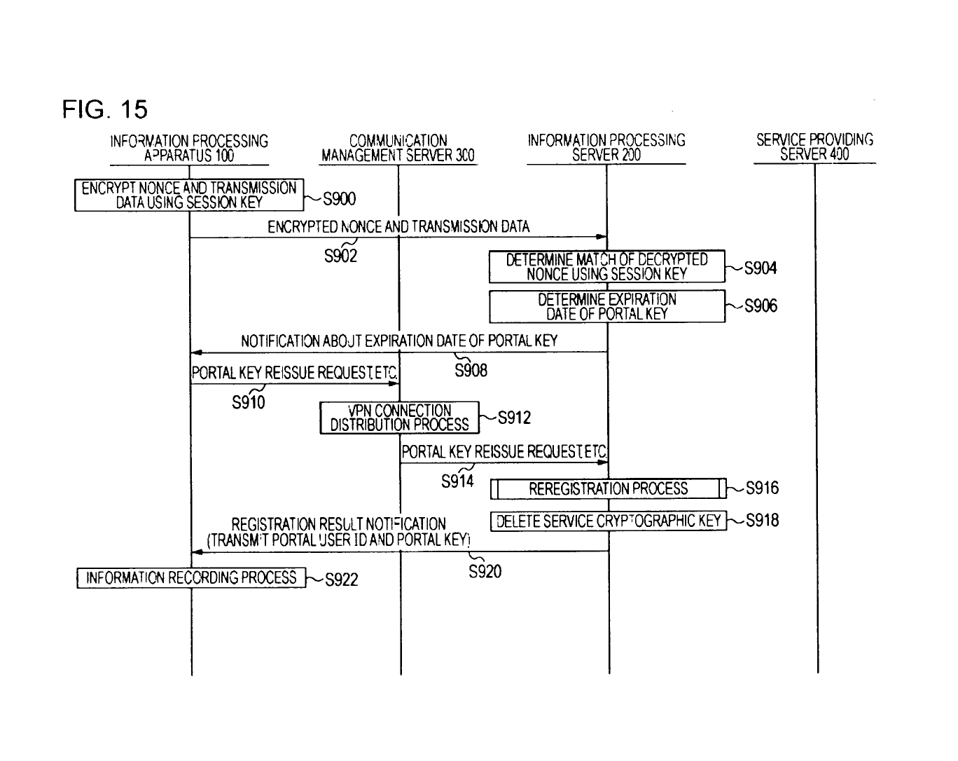

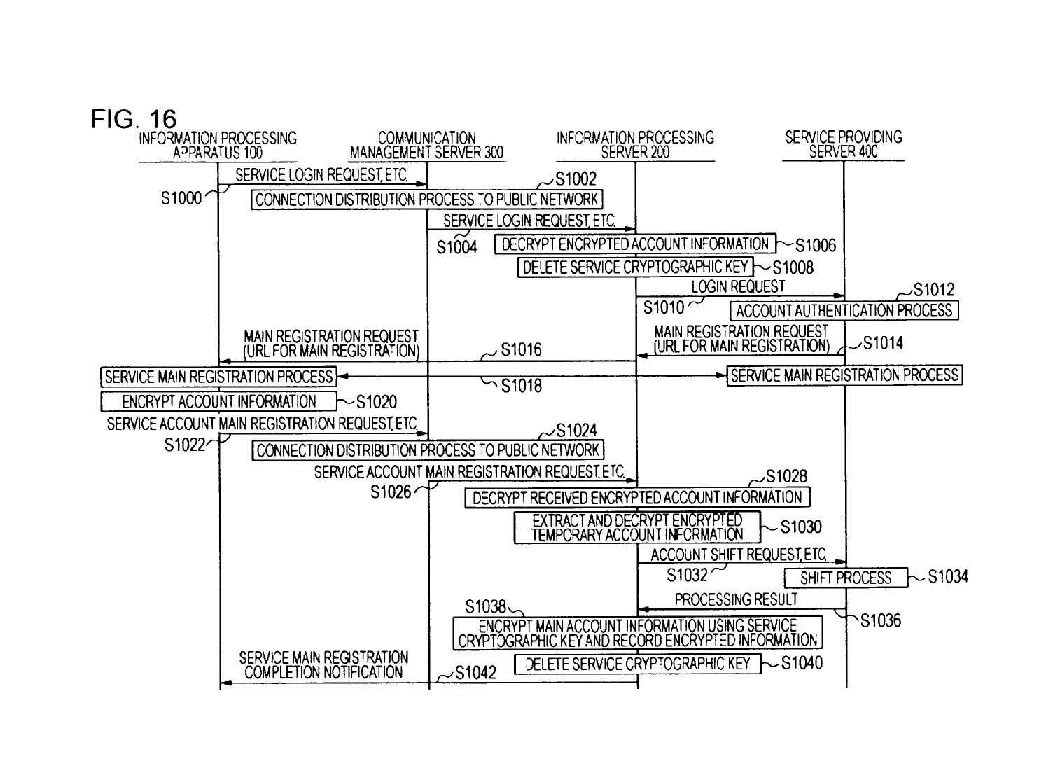

FIG. 15 illustrates a seventh example of a process related to an approach for increasing convenience according to the embodiment of the present invention. Here, FIG. 15 illustrates an example of a process that is performed in a case where the information processing apparatus 100 requests reissue of a portal key on the basis of a notification from the information processing server 200 when the portal key stored in step S134 in FIG. 7 is provided with an expiration date. Also, FIG. 15 illustrates a process that is performed in a case where a session key is shared through the login process illustrated in FIGS. 11 and 12 between the information processing apparatus 100 and the information processing server 200.

The information processing apparatus 100 encrypts a nonce and transmission data by using a session key (step S900). Then, the information processing apparatus 100 transmits the encrypted nonce and transmission data to the information processing server 200 (step S902).

The information processing server 200 that has received the encrypted nonce and transmission data transmitted in step S902 decrypts the encrypted nonce and transmission data by using the session key. Then, the information processing server 200 determines whether the nonce matches (step S904). In a case where the nonce does not match in step S904, the information processing server 200 transmits an error notification to the information processing apparatus 100.

In a case where the nonce matches in step S904, the information processing server 200 determines the expiration date of the portal key (step S906). Then, the information processing server 200 notifies the information processing apparatus 100 of information indicating the expiration date of the portal key (step S908).

The information processing apparatus 100 that has received information indicating the expiration date of the portal key transmitted in step S908 determines whether the portal key is expired on the basis of the received information. Hereinafter, a description will be given about a case where the information processing apparatus 100 determines that the portal key is expired.

As in step S202 in FIG. 8, the information processing apparatus 100 transmits a portal key reissue request, identification information, and a service cryptographic key to the communication management server 300 (step S910).

The communication management server 300 that has received the portal key reissue request transmitted in step S910 performs distribution to VPN connection based on a URL or the like, as in step S106 in FIG. 7 (step S912). Then, the communication management server 300 transmits the portal key reissue request, identification information, and service cryptographic key to the information processing server 200 (step S914).

The information processing server 200 that has received the portal key reissue request transmitted in step S914 performs a reregistration process in response to the portal key reissue request, as in step S208 in FIG. 8 (step S916). Then, after the reregistration process ends in step S916, the information processing server 200 deletes the service cryptographic key stored in the first storage unit, as in step S122 in FIG. 7 (step S918).

As in step S214 in FIG. 8, the information processing server 200 transmits a registration result notification indicating a result of the process performed in response to the portal key reissue request to the information processing apparatus 100 (step S920).

The information processing apparatus 100 that has received the registration result notification transmitted from the information processing server 200 in step S920 stores the portal user ID and portal key transmitted together with the registration result notification indicating that the process has been normally completed, as in step S134 in FIG. 7 (step S922).

In a case where the information processing apparatus 100 transmits a portal key reissue request on the basis of a notification from the information processing server 200, the process illustrated in FIG. 15 is performed in the information processing system 1000. Of course, the process that is performed in a case where the information processing apparatus 100 transmits a portal key reissue request on the basis of a notification from the information processing server 200 according to the embodiment of the present invention is not limited to the process illustrated in FIG. 15.

### (8) Service Account Main Registration Request

FIG. 16 illustrates an eighth example of a process related to an approach for increasing convenience according to the embodiment of the present invention. Here, FIG. 16 illustrates an example of a process that is performed in the case of performing shift from a temporary service account to a main account when a temporary account registered in the process based on the initial registration request illustrated in FIG. 7 is expired. In FIG. 16, it is assumed that the communication channel used for communication between the information processing apparatus 100 and the information processing server 200 is encrypted with a session key shared through the login process illustrated in FIGS. 11 and 12, and a description about a process related to the encryption is omitted.

As in step S800 in FIG. 14, the information processing apparatus 100 transmits a service login request, identification information, and a service cryptographic key to the communication management server 300 (step S1000).

The communication management server 300 that has received the service login request transmitted in step S1000 performs connection distribution to a public network, such as the Internet, on the basis of a URL or the like, as in step S504 in FIG. 11 (step S1002). Then, the communication management server 300 transmits the service login request, identification information, and service cryptographic key to the information processing server 200 (step S1004).

The information processing server 200 that has received the service login request transmitted in step S1004 decrypts the encrypted account information associated with the received identification information in response to the service login request, as in step S806 in FIG. 14 (step S1006).

After the encrypted account information is decrypted in step S1006, the information processing server 200 deletes the service cryptographic key stored in the first storage unit, as in step S122 in FIG. 7 (step S1008).

The information processing server 200 transmits a login request and account information to the service providing server 400 by using the account information obtained in step S1006, as in step S810 in FIG. 14 (step S1010).

The service providing server 400 performs account authentication on the basis of the account information transmitted from the information processing server 200 in step S1010 (step S1012). In FIG. 16, a description will be given under the assumption that the service providing server 400 determines to request main registration in step S1012 because a temporary account is expired.

On the basis of the processing result of step S1012, the service providing server 400 transmits a main registration request for requesting main registration for a service to the information processing server 200 (step S1014). Here, when determining to request main registration in step S1012, the service providing server 400 also transmits information about main registration, such as a URL for main registration, in step S1014.

The information processing server 200 that has received the main registration request transmitted in step S1014 transmits the received main registration request to the information processing apparatus 100 (step S1016). Then, the information processing apparatus 100 accesses the URL for main registration on the basis of the received information about the main registration request, and inputs a main user ID, password, user information, and so on related to main registration in accordance with a user operation (step S1018). By performing step S1018, the information processing apparatus 100 can obtain account information related to main registration, such as a main user ID and password.

The information processing apparatus 100 encrypts the obtained account information by using the service cryptographic key corresponding to the service related to the account information (step S1020).

The information processing apparatus 100 transmits a service account main registration request, identification information, encrypted account information, and service cryptographic key to the communication management server 300 (step S1022).

The communication management server 300 that has received the service account main registration request transmitted in step S1022 performs connection distribution to a public network, such as the Internet, on the basis of a URL or the like, as in step S504 in FIG. 11 (step S1024). Then, the communication management server 300 transmits the service account main registration request, identification information, encrypted account information, and service cryptographic key to the information processing server 200 (step S1026).

The information processing server 200 that has received the service account main registration request transmitted in step S1026 decrypts the received encrypted service account information by using the service cryptographic key stored in the first storage unit in response to the service account main registration request (step S1028). Also, the information processing server 200 decrypts encrypted account information (encrypted temporary account information) associated with the received identification information included in the service account information (e.g., FIG. 5) in step S1030. The information processing server 200 can obtain account information related to main registration by performing step S1028, and can obtain account information related to temporary registration by performing step S1030.

The information processing server 200 transmits an account shift request to the service providing server 400 that provides a service corresponding to the account information obtained in steps S1028 and S1030 (step S1032). Here, the information processing server 200 transmits, to the service providing server 400, the account information related to main registration obtained in step S1028 and the account information related to temporary registration obtained in step S1030 together with the account shift request.

The service providing server 400 performs shift from the temporary account to the main account in response to the account shift request transmitted in step S1032 (step S1034: shift process). Then, the service providing server 400 transmits a processing result to the information processing server 200 (step S1036).

The information processing server 200 that has received the processing result indicating that the process has been successfully performed from the service providing server 400 in step S1036 encrypts the main account information by using the service cryptographic key stored in the first storage unit and records the encrypted main account information (step S1038). Here, the main account information recorded in step S1038 is account information that is obtained by decrypting the received encrypted service account information. Also, in step S1038, the information processing server 200 stores the encrypted account information in the form of being associated with the identification information illustrated in FIG. 4 via a portal user ID, as illustrated in FIG. 5. Alternatively, another storage form may be used.

After step S1038, the information processing server 200 deletes the service cryptographic key stored in the first storage unit, as in step S122 in FIG. 7 (step S1040).

Then, the information processing server 200 transmits, to the information processing apparatus 100, a service main registration completion notification indicating that main registration with the service corresponding to the service account main registration request has been completed (step S1042).

In a case where the information processing apparatus 100 transmits a service account main registration request, the process illustrated in FIG. 16 is performed in the information processing system 1000. Of course, the process that is performed in a case where the information processing apparatus 100 transmits a service account main registration request according to the embodiment of the present invention is not limited to the process illustrated in FIG. 16.

### (9) Shift Request/Shift Registration Request

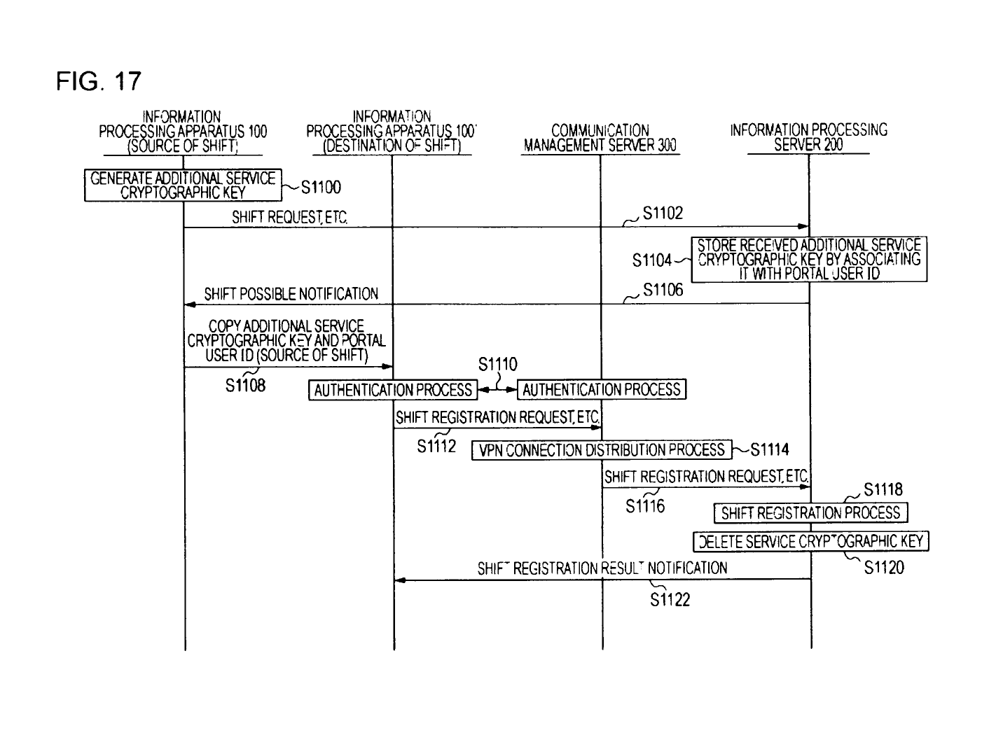

FIG. 17 illustrates a ninth example of a process related to an approach for increasing convenience according to the embodiment of the present invention. Here, FIG. 17 illustrates an example of a process that is performed in the case of enabling another information processing apparatus (hereinafter referred to as “information processing apparatus 100′”) to use a service that is available in the information processing apparatus 100.

Hereinafter, the ninth example of a process related to an approach for increasing convenience will be described under the assumption that the information processing apparatus 100 is an information processing apparatus serving as a source of shift and that the information processing apparatus 100′ is an information processing apparatus serving as a destination of shift. Also, in FIG. 17, it is assumed that the communication channel used for communication between the information processing apparatus 100 and the information processing server 200 is encrypted with a session key that is shared through the login process illustrated in FIGS. 11 and 12, and a description about a process related to the encryption is omitted.

The information processing apparatus 100 generates a new service cryptographic key used for shift (hereinafter referred to as “additional service cryptographic key”) in step 1100. Then, the information processing apparatus 100 transmits a shift request for requesting shift of an information processing apparatus capable of using a service, identification information, and the additional service cryptographic key to the information processing server 200 (step S1102).

The information processing server 200 that has received the shift request transmitted in step S1102 stores the received additional service cryptographic key by associating it with the portal user ID corresponding to the information processing apparatus 100 (step S1104). Here, the information processing server 200 can uniquely specify the portal user ID corresponding to the information processing apparatus 100 on the basis of the received identification information and portal account information.

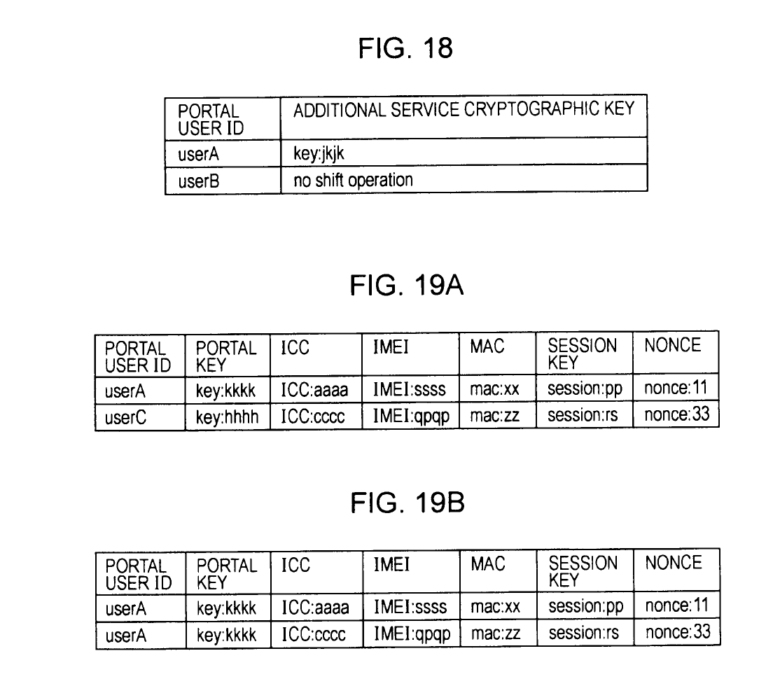

FIG. 18 illustrates an example of the information stored in the information processing apparatus 100 according to the embodiment of the present invention. Here, FIG. 18 illustrates an example in which portal user IDs and additional service cryptographic keys are stored in the table while being associated with each other.

When receiving a shift request, the information processing server 200 stores the additional service cryptographic key that is received together with the shift request by associating it with the portal user ID, as illustrated in FIG. 18. The method for storing additional service cryptographic keys in the information processing server 200 according to the embodiment of the present invention is not limited to the foregoing method.

Referring back to FIG. 17, a description will be further given about the ninth example of a process related to an approach for increasing convenience. The information processing server 200 transmits a shift possible notification indicating that shift can be performed to the information processing apparatus 100 (step 1106).

The information processing apparatus 100 that has received the shift possible notification transmitted in step S1106 copies the additional service cryptographic key generated in step S1100 and the portal user ID (source of shift) to the information processing apparatus 100′ (step S1108).

Here, the information processing apparatus 100 can copy the additional service cryptographic key and portal user ID (source of shift) to the information processing apparatus 100′ by using a communication channel that is formed of near field communication (NFC) or the like, but the copy may be performed in another manner. For example, the copy of the additional service cryptographic key and portal user ID (source of shift) between the information processing apparatuses 100 and 100′ can be realized via a removable external memory or the like. Alternatively, a user may input the additional service cryptographic key and portal user ID (source of shift) to the information processing apparatus 100′. In a case where the information processing apparatuses 100 and 100′ perform copy of the additional service cryptographic key, etc., by using the communication channel formed of NFC, one of the information processing apparatuses 100 and 100′ plays a role of a reader/writer (a transmitter that mainly transmits carrier).

As in step S100 in FIG. 7, the information processing apparatus 100′ communicates with the communication management server 300 via the wireless network 500, so that the information processing apparatus 100′ and the communication management server 300 perform an authentication process (step S1110).

The information processing apparatus 100′ transmits a shift registration request for requesting registration related to the shift, identification information, portal user ID (source of shift), and additional service cryptographic key to the communication management server 300 (step S1112).

The communication management server 300 that has received the shift registration request transmitted in step S1112 performs distribution to VPN connection based on a URL or the like, as in step S106 in FIG. 7 (step S1114). Then, the communication management server 300 transmits the shift registration request, identification information, portal user ID (source of shift), and additional service cryptographic key to the information processing server 200 (step S1116).

The information processing server 200 that has received the shift registration request transmitted in step S1116 performs a shift registration process in response to the shift registration request (step S1118).

### Example of Shift Registration Process

FIGS. 19A and 19B are for explaining the shift registration process performed in the information processing server 200 according to the embodiment of the present invention. Here, FIGS. 19A and 19B illustrate part of portal account information. Hereinafter, an example of the shift registration process performed in the information processing server 200 will be described with reference to FIGS. 19A and 19B.

The information processing server 200 realizes the shift registration process by performing the following processes (a) to (c), for example.

### (a) New User Registration Process

The information processing server 200 records a new portal user ID corresponding to received identification information in portal account information. In FIG. 19A, user A corresponds to the information processing apparatus 100 serving as a source of shift, whereas user C corresponds to the information processing apparatus 100′ serving as a destination of shift newly recorded.

### (b) Process of Determining Matching of Additional Service Cryptographic Key

After the foregoing process (a) has been completed, the information processing server 200 determines whether the received additional service cryptographic key matches the additional service cryptographic key corresponding to the received portal user ID (source of shift). Here, the information processing server 200 specifies the additional service cryptographic key corresponding to the received portal user ID (source of shift) on the basis of the received portal user ID (source of shift) and the information stored in step S1104.

In a case where the received additional service cryptographic key does not match the additional service cryptographic key corresponding to the received portal user ID (source of shift), the information processing server 200 ends the shift registration process.

### (c) Registration Process

In a case where it is determined in the foregoing process (b) that the additional service cryptographic keys match each other, the information processing server 200 overwrites the newly-recorded information about the portal user ID of the destination of shift in the portal account information with the information about the portal user ID of the source of shift. FIG. 19B illustrates an example in which “user C” corresponding to the information processing apparatus 100′ serving as the destination of shift and the portal cryptographic key corresponding to user C illustrated in FIG. 19A are overwritten with “user A” corresponding to the information processing apparatus 100 serving as the source of shift and the portal cryptographic key corresponding to user A.

After performing the foregoing processes (a) to (c), the information processing server 200 can recognize the information processing apparatus 100′ serving as the destination of shift as user A that corresponds to the information processing apparatus 100 serving as the source of shift.

The information processing server 200 realizes the shift registration process by performing the foregoing processes (a) to (c). Of course, the shift registration process performed by the information processing server 200 according to the embodiment of the present invention is not limited to the foregoing processes (a) to (c).

Referring back to FIG. 17, a description will be further given about the ninth example of a process related to an approach for increasing convenience. After the shift registration process in step S1118 ends, the information processing server 200 deletes the service cryptographic key (step S1120). Here, the information processing server 200 deletes the service cryptographic key stored in the first storage unit (received additional service cryptographic key) as in step S122 in FIG. 7, and also deletes the additional service cryptographic key stored in step S1104. Also, the information processing server 200 changes the additional service cryptographic key associated with user A illustrated in FIG. 18 to a value representing that the shift operation has been completed, thereby deleting the additional service cryptographic key stored in step S1104, but another method may also be used.

The information processing server 200 transmits a shift registration result notification indicating the result of the process performed in response to the shift registration request to the information processing apparatus 100 (step S1122).

In a case where the information processing apparatus 100 transmits a shift request, the process illustrated in FIG. 17 is performed in the information processing system 1000. Of course, the process that is performed in a case where the information processing apparatus 100 transmits a shift request according to the embodiment of the present invention is not limited to the process illustrated in FIG. 17.

### (10) Account Deletion Request

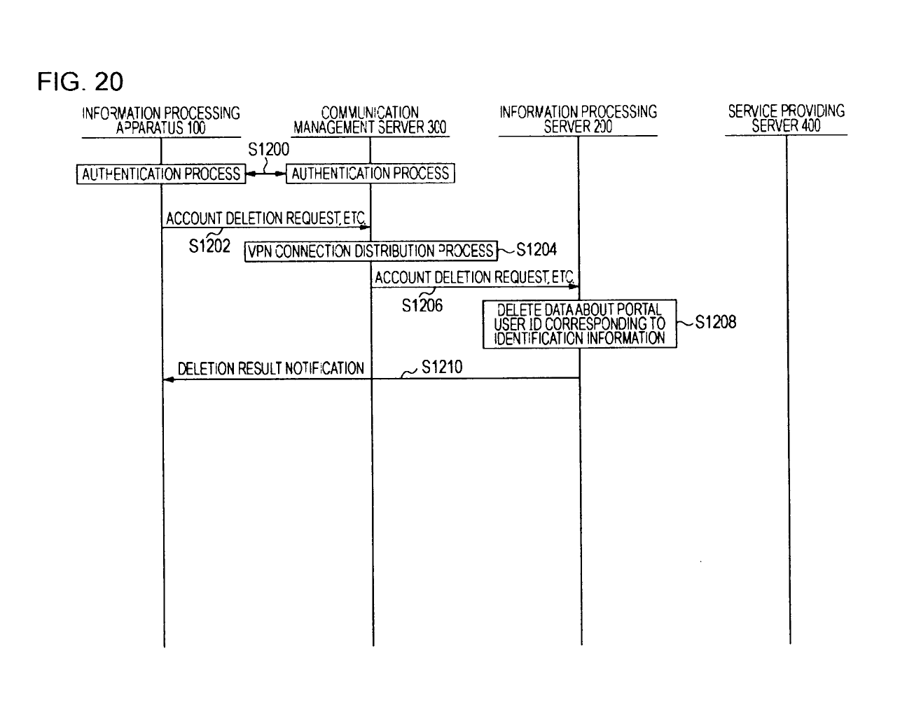

FIG. 20 illustrates a tenth example of a process related to an approach for increasing convenience according to the embodiment of the present invention. Here, FIG. 20 illustrates an example of a process that is performed in a case where the information processing apparatus 100 requests deletion of information about an account for using the information processing server 200.

As in step S100 in FIG. 7, the information processing apparatus 100 communicates with the communication management server 300 via the wireless network 500, so that the information processing apparatus 100 and the communication management server 300 performs an authentication process (step S1200).

The information processing apparatus 100 transmits an account deletion request and identification information to the communication management server 300 (step S1202).

The communication management server 300 that has received the account deletion request transmitted in step 51202 performs distribution to VPN connection based on a URL or the like, as in step S106 in FIG. 7 (step S1204). Then, the communication management server 300 transmits the account deletion request and identification information to the information processing server 200 (step S1206).

The information processing server 200 that has received the account deletion request transmitted in step S1206 deletes data about the portal user ID corresponding to the received identification information in response to the account deletion request (step 1208).

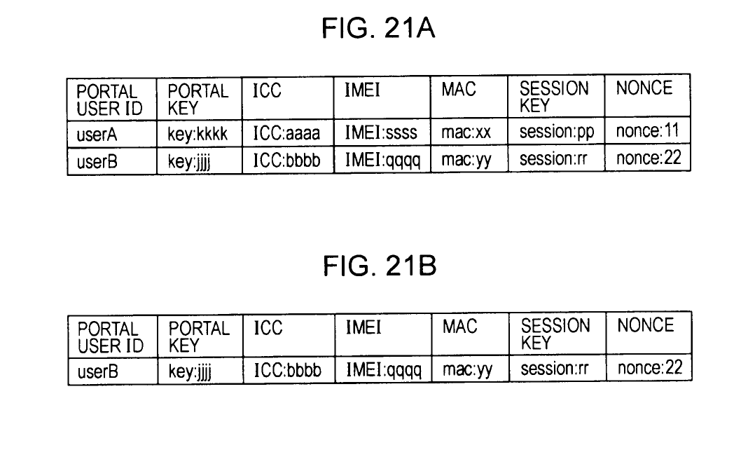

FIGS. 21A and 21B are for explaining an example of a process related to deletion of data about the portal user ID in the information processing server 200 according to the embodiment of the present invention. Here, FIG. 21A illustrates part of portal account information before the data about the portal user ID is deleted, whereas FIG. 21B illustrates part of portal account information after the data about the portal user ID is deleted.

As illustrated in FIGS. 21A and 21B, the information processing server 200 deletes the data corresponding to the portal user ID corresponding to the received identification information from the portal account information. The process related to deletion of data about a portal user ID in the information processing server 200 according to the embodiment of the present invention is not limited to the foregoing process. For example, the information processing server 200 according to the embodiment of the present invention can realize deletion by invalidating the data corresponding to the portal user ID corresponding to the received identification information.

The information processing server 200 transmits a deletion result notification indicating a result of the process that is performed in response to the account deletion request to the information processing apparatus 100 (step S1210).

In a case where the information processing apparatus 100 transmits an account deletion request, the process illustrated in FIG. 20 is performed in the information processing system 1000. Of course, the process that is performed in a case where the information processing apparatus 100 transmits an account deletion request according to the embodiment of the present invention is not limited to the process illustrated in FIG. 20.

In the information processing system 1000, the foregoing processes (1) to (10) (processes related to an approach for increasing convenience) are performed in response to processing requests transmitted from the information processing apparatus 100. Of course, the processes related to an approach for increasing convenience according to the embodiment of the present invention are not limited to the foregoing processes (1) to (10).

### Information Processing Apparatus and Information Processing Server According to the Embodiment of the Present Invention

Next, a description will be given about configuration examples of the information processing apparatus 100 and the information processing server 200 according to the embodiment of the present invention that constitute the information processing system 1000 and that are capable of realizing an approach for increasing convenience according to the embodiment of the present invention. The other information processing apparatuses that can constitute the information processing system 1000 according to the embodiment of the present invention may have the same function and configuration as those of the information processing apparatus 100, and thus the corresponding description is omitted.

### Information Processing Apparatus 100

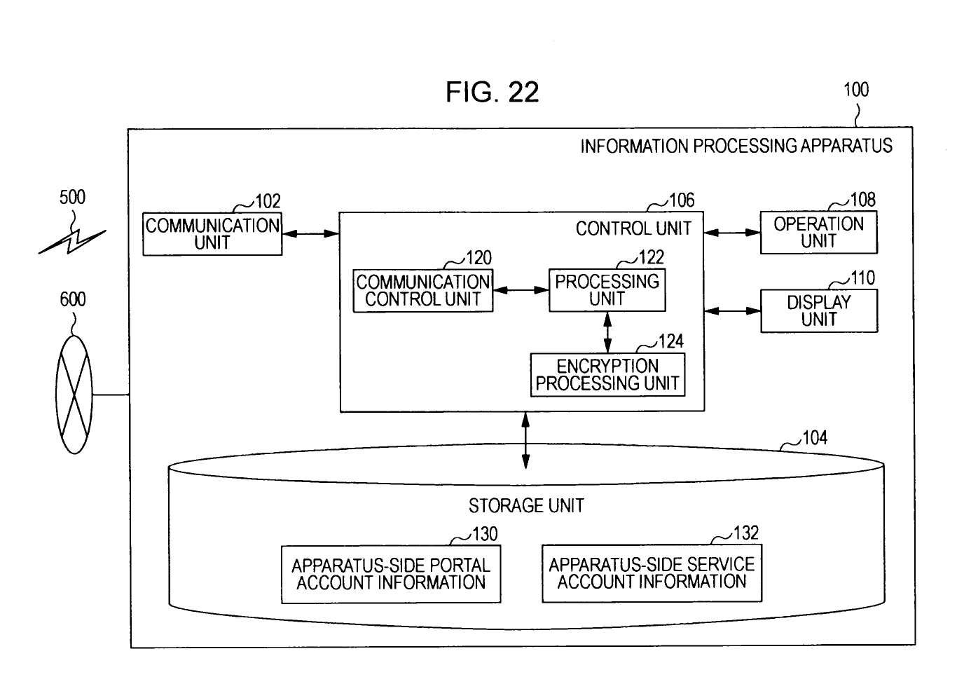

First, a configuration example of the information processing apparatus 100 constituting the information processing system 1000 will be described. FIG. 22 illustrates an example of the configuration of the information processing apparatus 100 according to the embodiment of the present invention. The information processing apparatus 100 includes a communication unit 102, a storage unit 104, a control unit 106, an operation unit 108, and a display unit 110.

Also, the information processing apparatus 100 may include a read only memory (ROM) and a random access memory (RAM) that are not illustrated. In the information processing apparatus 100, the individual elements are mutually connected via a bus serving as a data transmission path.

Here, the ROM (not illustrated) stores programs and control data, such as computation parameters, used by the control unit 106. The RAM (not illustrated) temporarily stores a program executed by the control unit 106.

### Hardware Configuration Example of Information Processing Apparatus 100

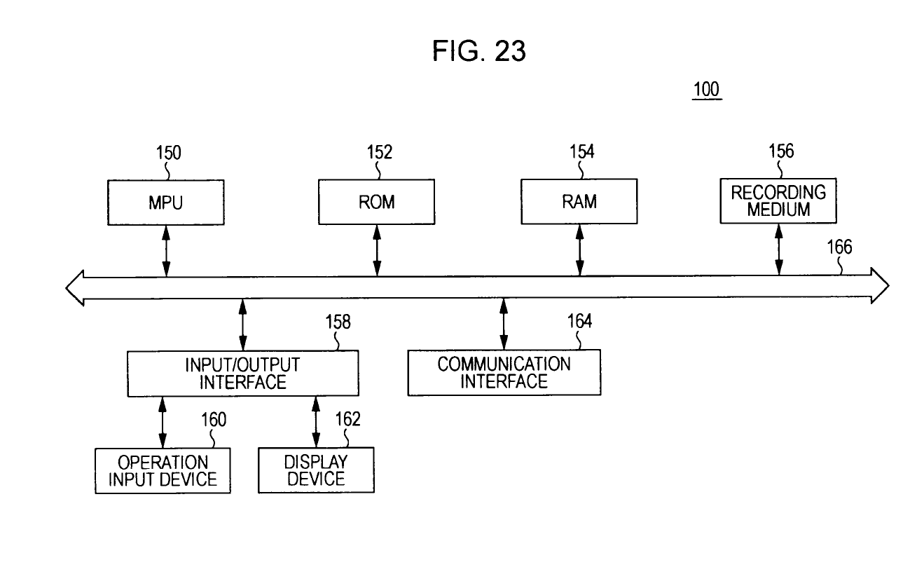

FIG. 23 illustrates an example of the hardware configuration of the information processing apparatus 100 according to the embodiment of the present invention.

Referring to FIG. 23, the information processing apparatus 100 includes, for example, a microprocessing unit (MPU) 150, a ROM 152, a RAM 154, a recording medium 156, an input/output interface 158, an operation input device 160, a display device 162, and a communication interface 164. In the information processing apparatus 100, the individual elements are mutually connected via a bus 166 serving as a data transmission path.

The MPU 150 is configured using an integrated circuit in which a plurality of circuits for realizing an MPU and a control function are integrated, and functions as the control unit 106 that controls the entire information processing apparatus 100. Also, the MPU 150 can play a role of a communication control unit 120, a processing unit 122, and an encryption processing unit 124 described below in the information processing apparatus 100.

The ROM 152 stores programs and control data, such as computation parameters, used by the MPU 150. The RAM 154 temporarily stores a program executed by the MPU 150.

The recording medium 156 functions as the storage unit 104 and stores various data, such as apparatus-side portal account information (e.g., FIG. 3), apparatus-side service account information (e.g., FIG. 2), and applications. Here, examples of the recording medium 156 include a magnetic recording medium, such as a hard disk, and a nonvolatile memory, such as an electrically erasable and programmable read only memory (EEPROM), a flash memory, a magnetoresistive random access memory (MRAM), a ferroelectric random access memory (FeRAM), and a phase change random access memory (PRAM).

The input/output interface 158 is used to connect the operation input device 160 and the display device 162, for example. The operation input device 160 functions as the operation unit 108, and the display device 162 functions as the display unit 110. Here, examples of the input/output interface 158 include a universal serial bus (USE) terminal, a digital visual interface (DVI) terminal, a high-definition multimedia interface (HDMI) terminal, and various types of processing circuits. Also, the operation input device 160 is provided on the information processing apparatus 100 and is connected to the input/output interface 158 inside the information processing apparatus 100. Examples of the operation input device 160 include a button, a direction key, a rotary selector such as a jog dial, and a combination of those components. The display device 162 is provided on the information processing apparatus 100 and is connected to the input/output interface 158 inside the information processing apparatus 100. Examples of the display device 162 include a liquid crystal display (LCD) and an organic electroluminescence (EL) display (also called an organic light-emitting diode (OLED) display). Of course, the input/output interface 158 can also be connected to an operation input device (e.g., a keyboard and a mouse) and a display device (e.g., an external display) serving as an external device of the information processing apparatus 100.

The communication interface 164 is a communication unit of the information processing apparatus 100 and functions as the communication unit 102 for performing communication with an external apparatus in a wireless/wired manner via the wireless network 500/network 600 (or directly). Here, examples of the communication interface 164 include a communication antenna and an RF circuit (wireless communication), an IEEE 802.15.1 port and a transmission/reception circuit (wireless communication), an IEEE802.11b port and a transmission/reception circuit (wireless communication), and a LAN terminal and a transmission/reception circuit (wired communication).

With the configuration illustrated in FIG. 22, the information processing apparatus 100 can perform the foregoing processes (i) (transmission of various pieces of information) and (ii) (execution of a process based on received information) related to an approach for increasing convenience. The hardware configuration of the information processing apparatus 100 according to the embodiment of the present invention is not limited to the configuration illustrated in FIG. 22.

Referring back to FIG. 22, the elements of the information processing apparatus 100 will be described. The communication unit 102 is a communication unit of the information processing apparatus 100, and communicates with an external apparatus in a wireless/wired manner via the wireless network 500/network 600 (or directly). The communication performed by the communication unit 102 is controlled by the communication control unit 120 described below.

Here, examples of the communication unit 102 include a communication antenna and an RF circuit and/or an IEEE802.11b port and a transmission/reception circuit. For example, the communication unit 102 may have an arbitrary configuration that is capable of communicating with an external apparatus via the wireless network 500 or the network 600.

The storage unit 104 is a storage unit of the information processing apparatus 100. Here, examples of the storage unit 104 include a magnetic recording medium such as a hard disk and a nonvolatile memory such as a flash memory.

Also, the storage unit 104 stores various data, such as apparatus-side portal account information (e.g., FIG. 3), apparatus-side service account information (e.g., FIG. 2), and applications. Here, FIG. 22 illustrates an example in which apparatus-side portal account information 130 and apparatus-side service account information 132 are stored in the storage unit 104, but another storage form may also be accepted.

The control unit 106 is configured using an MPU or an integrated circuit in which various processing circuits are integrated, and plays a role in controlling the entire information processing apparatus 100. Also, the control unit 106 includes the communication control unit 120, processing unit 122, and the encryption processing unit 124, and plays a leading role in performing the foregoing processes (i) (transmission of various pieces of information) and (ii) (execution of a process based on received information).

The communication control unit 120 controls communication with an external apparatus via the wireless network 500/network 600 (or directly). More specifically, the communication control unit 120 controls communication on the basis of a process performed by the processing unit 122. With the communication control performed by the communication control unit 120, the information processing apparatus 100 can communicate with the information processing server 200 selectively via the communication management server 300, as described above in the description about the processes (1) to (10).

The processing unit 122 plays a role in performing the foregoing processes (i) (transmission of various pieces of information) and (ii) (execution of a process based on received information).

More specifically, the processing unit 122 generates a processing request on the basis of an operation signal based on a user operation transmitted from the operation unit 108. Then, in accordance with the type of the generated processing request, the processing unit 122 causes the communication control unit 120 to transmit the generated processing request, a service cryptographic key corresponding to the service indicated by the processing request, and identification information.

Also, the processing unit 122 performs a process in accordance with received information on the basis of information that is transmitted from the information processing server 200 in response to the transmitted processing request and that is received by the communication unit 102 (e.g., the initial registration result notification illustrated in FIG. 7).

The encryption processing unit 124 performs an encryption process on the basis of a process performed by the processing unit 122, e.g., generation of a service cryptographic key, decryption of information (data) using a portal key, and encryption of information using a session key.

The control unit 106 can play a leading role in performing the foregoing processes (i) (transmission of various pieces of information) and (ii) (execution of a process based on received information) by including the communication control unit 120, the processing unit 122, and the encryption processing unit 124.

The operation unit 108 is an operation unit that enables a user to perform an operation and that is included in the information processing apparatus 100. With the operation unit 108, the information processing apparatus 100 enables a user to perform an operation and can perform a process desired by the user in accordance with the operation. Here, examples of the operation unit 108 include a button, a direction key, a rotary selector such as a jog dial, and a combination of those components.

The display unit 110 is a display unit of the information processing apparatus 100 and displays various pieces of information on its display screen. Examples of a screen displayed on the display screen of the display unit 110 include an application execution screen, a display screen showing a communication status, and an operation screen for causing the information processing apparatus 100 to perform a desired operation. Here, examples of the display unit 110 include an LCD and an organic EL display. Alternatively, a touch screen may be used as the display unit 110 in the information processing apparatus 100. In that case, the display unit 110 functions as an operation display unit capable of performing both user operation and display.

With the configuration illustrated in FIG. 22, the information processing apparatus 100 can realize the foregoing processes (i) (transmission of various pieces of information) and (ii) (execution of a process based on received information) related to an approach for increasing convenience. Of course, the configuration of the information processing apparatus according to the embodiment of the present invention is not limited to the configuration illustrated in FIG. 22.

### Information Processing Server 200

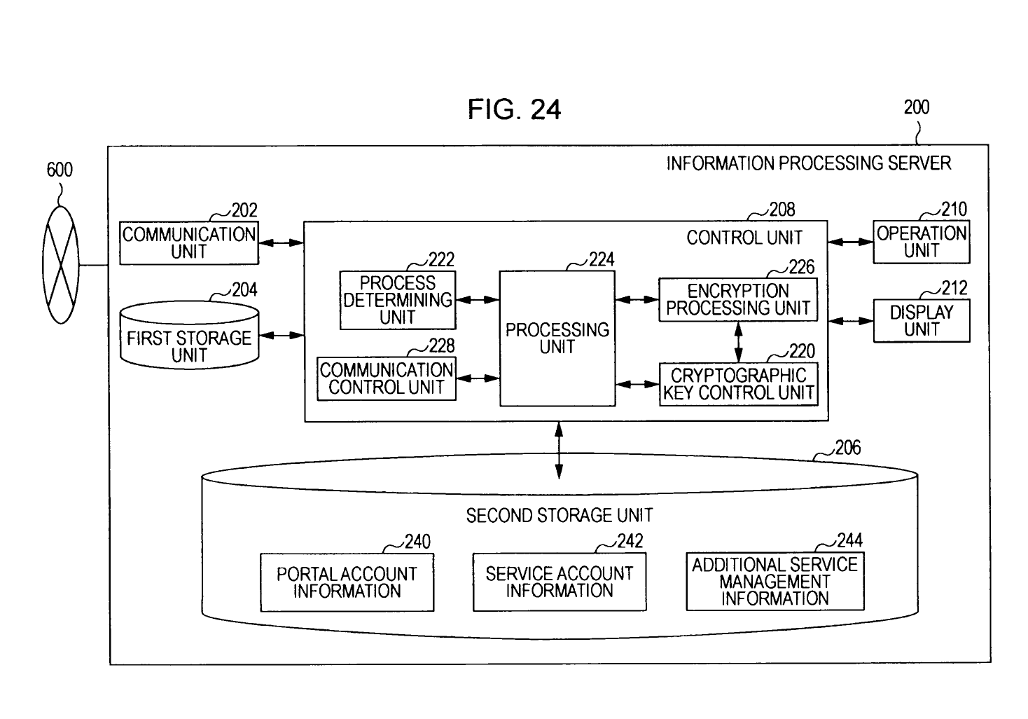

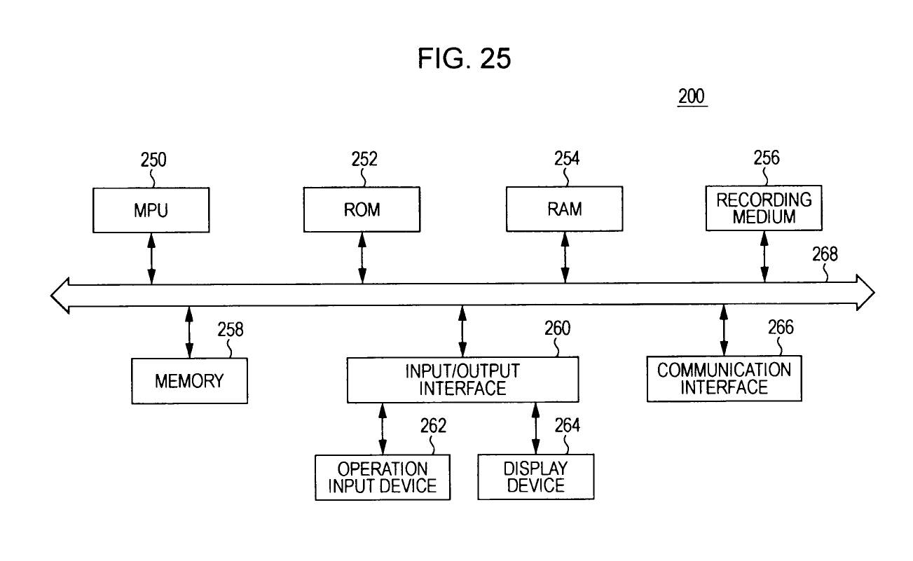

Next, a configuration example of the information processing server 200 constituting the information processing system 1000 will be described. FIG. 24 illustrates an example of the configuration of the information processing server 200 according to the embodiment of the present invention. The information processing server 200 includes a communication unit 202, a first storage unit 204, a second storage unit 206, a control unit 208, an operation unit 210, and a display unit 212.

Also, the information processing server 200 may include a ROM (not illustrated) and a RAM (not illustrates), for example. In the information processing server 200, the individual elements are mutually connected via a bus serving as a data transmission path.

Here, the ROM (not illustrated) stores programs and control data, such as computation parameters, used by the control unit 208. The RAM (not illustrated) temporarily stores a program executed by the control unit 208.

### Hardware Configuration Example of Information Processing Server 200

FIG. 25 illustrates an example of a hardware configuration of the information processing server 200 according to the embodiment of the present invention. With reference to FIG. 25, the information processing server 200 includes an MPU 250, a ROM 252, a RAM 254, a recording medium 256, a memory 258, an input/output interface 260, an operation input device 262, a display device 264, and a communication interface 266. In the information processing server 200, the individual elements are mutually connected via a bus 268 serving as a data transmission path.

The MPU 250 is configured using an integrated circuit in which a plurality of circuits for realizing an MPU and a control function are integrated, and functions as the control unit 208 that controls the entire information processing server 200. Also, the MPU 250 can play a role of a cryptographic key control unit 220, a process determining unit 222, a processing unit 224, an encryption processing unit 226, and a communication control unit 228 that will be described below in the information processing server 200.

The ROM 252 stores programs and control data, such as computation parameters, used by the MPU 250. The RAM 254 temporarily stores a program executed by the MPU 250.

The recording medium 256 functions as the second storage unit 206 and stores various data, such as portal account information (e.g., FIG. 4), service account information (e.g., FIG. 5), additional service management information (e.g., FIG. 6), and applications. Here, examples of the recording medium 256 include a magnetic recording medium, such as a hard disk, and a nonvolatile memory, such as an EEPROM, a flash memory, an MRAM, an FeRAM, and a PRAM.

The memory 258 functions as the first storage unit 204 and (temporarily) stores a service cryptographic key that is transmitted from an external apparatus, such as the information processing apparatus 100, and that is received by the communication unit 202. Also, recording of a service cryptographic key in the memory 258 and deletion of a service cryptographic key from the memory 258 are controlled by the cryptographic key control unit 220 described below.

Here, examples of the memory 258 include a volatile memory, such as an SDRAM and an SRAM. Alternatively, the information processing server 200 may include a nonvolatile memory, such as an EEPROM, serving as the memory 258. Even in a case where a nonvolatile memory is used as the memory 258, the cryptographic key control unit 220 deletes a stored service cryptographic key, so that an approach for increasing convenience can be realized according to the embodiment of the present invention.

The input/output interface 260 is used to connect the operation input device 262 and the display device 264, for example. The operation input device 262 functions as the operation unit 210, whereas the display device 264 functions as the display unit 212. Here, examples of the input/output interface 260 include a USB terminal, a DVI terminal, an HDMI terminal, and various processing circuits. The operation input device 262 is provided on the information processing server 200 and is connected to the input/output interface 260 inside the information processing server 200, for example. Examples of the operation input device 262 include a button, a direction key, a rotary selector such as a jog dial, and a combination of those components. The display device 264 is provided on the information processing server 200 and is connected to the input/output interface 260 inside the information processing server 200, for example. Examples of the display device 264 include an LCD and an organic EL display. Of course, the input/output interface 260 can be connected to an operation input device (e.g., a keyboard and a mouse) and a display device (e.g., an external display) serving as an external device of the information processing server 200.

The communication interface 266 is a communication unit of the information processing server 200 and functions as the communication unit 202 for performing communication with an external apparatus in a wireless/wired manner via the network 600 (or directly). Here, examples of the communication interface 266 include a communication antenna and an RF circuit (wireless communication), an IEEE802.15.1 port and a transmission/reception circuit (wireless communication), an IEEE802.11b port and a transmission/reception circuit (wireless communication), and a LAN terminal and a transmission/reception circuit (wired communication).

With the configuration illustrated in FIG. 25, the information processing server 200 can perform the foregoing processes (I) (storage of a service cryptographic key) to (III) (execution of a process) related to an approach for increasing convenience. The hardware configuration of the information processing server 200 according to the embodiment of the present invention is not limited to the configuration illustrated in FIG. 25. For example, the information processing server according to the embodiment of the present invention may not include the memory 258, and the RAM 254 may function as the first storage unit 204. Also, the information processing server according to the embodiment of the present invention may not include the memory 258, and the recording medium 256 may function as the first storage unit 204 and the second storage unit 206.

Referring back to FIG. 24, the elements of the information processing server 200 will be described. The communication unit 202 is a communication unit of the information processing server 200, and performs communication (e.g., information communication) with an external apparatus, such as the information processing apparatus 100, the communication management server 300, and the service providing server 400, in a wireless/wired manner via the network 600 (or directly). The communication with each external apparatus performed by the communication unit 202 is controlled by the communication control unit 228 described below.

Here, examples of the communication unit 202 include a communication antenna and an RF circuit (wireless communication), and a LAN terminal and a transmission/reception circuit (wired communication).

The first storage unit 204 (temporarily) stores a service cryptographic key received by the communication unit 202. Also, recording of a service cryptographic key in the first storage unit 204 and deletion of a service cryptographic key from the first storage unit 204 are controlled by the cryptographic key control unit 220 described below.

Here, examples of the first storage unit 204 include a volatile memory, such as an SDRAM and an SRAM.

The second storage unit 206 is a storage unit of the information processing server 200. Here, examples of the second storage unit 206 include a magnetic recording medium, such as a hard disk, and a nonvolatile memory, such as a flash memory.

The second storage unit 206 stores various data, such as portal account information (e.g., FIG. 4), service account information (e.g., FIG. 5), additional service management information (e.g., FIG. 6), and applications. Here, FIG. 24 illustrates an example in which portal account information 240, service account information 242, and additional service management information 244 are stored in the second storage unit 206, but another storage form may also be accepted.

FIG. 24 illustrates a configuration in which the information processing server 200 includes two storage units that are physically different from each other, that is, the first storage unit 204 and the second storage unit 206. However, the configuration of the information processing server 200 is not limited thereto. For example, the information processing server according to the embodiment of the present invention may have a configuration including a single storage unit that plays a role of both the first and second storage units 204 and 206. With this configuration, the information processing server according to the embodiment of the present invention can prevent abuse of a service by a third party by causing the cryptographic key control unit 220 described below to control recording of a service cryptographic key in the storage unit and deletion of a service cryptographic key from the storage unit.

The control unit 208 is configured using an MPU or an integrated circuit in which various processing circuits are integrated, and plays a role in controlling the entire information processing server 200. Also, the control unit 208 includes the cryptographic key control unit 220, the process determining unit 222, the processing unit 224, the encryption processing unit 226, and the communication control unit 228, and plays a leading role in performing the foregoing processes (I) (storage of a service cryptographic key) to (III) (execution of a process). That is, the control unit 208 encrypts or decrypts information using a cryptographic key and plays a leading role in performing a process in response to a received processing request.

The cryptographic key control unit 220 plays a role in performing part of the foregoing processes (I) (storage of a service cryptographic key) to (III) (execution of a process). More specifically, the cryptographic key control unit 220 records a service cryptographic key received by the communication unit 202 in the first storage unit 204. Also, the cryptographic key control unit 220 deletes the service cryptographic key stored in the first storage unit 204 and the additional service cryptographic key illustrated in FIG. 18 on the basis of a process performed by the processing unit 224 and/or the encryption processing unit 226.

By including the control unit 208 that has the cryptographic key control unit 220, the information processing server 200 can prevent abuse of a service by a malicious third party using the service account information 242 that is stored in the second storage unit 206.

The process determining unit 222 plays a role in performing the foregoing process (II) (determination of a requested process). More specifically, the process determining unit 222 determines the type of process requested by an information processing apparatus that has transmitted a processing request received by the communication unit 202 on the basis of the processing request. Then, the process determining unit 222 transmits a determination result to the processing unit 224.

Here, the process determining unit 222 determines the type of process by interpreting an instruction included in the received processing request, but the determination may be performed in another way. For example, the process determining unit 222 can determine the type of process on the basis of a table in which process numbers indicating processes and the types of the processes are associated with each other and a process number included in a received processing request. Examples of the type of process determined by the process determining unit 222 include the processing requests described above in the foregoing examples (1) to (10).

The processing unit 224 plays a role in performing the foregoing process (III) (execution of process) and leads a process in accordance with a determination result transmitted from the process determining unit 222 on the basis of the determination result. Here, examples of a process led by the processing unit 224 include processes that are performed by the information processing server 200 in response to the processing requests described above in the foregoing examples (1) to (10).

Also, the processing unit 224 performs a process based on a determination result transmitted from the process determining unit 222 in cooperation with the encryption processing unit 226, the cryptographic key control unit 220, and the communication control unit 228. For example, the processing unit 224 causes the encryption processing unit 226 to perform a process in a case where encryption/decryption of information is necessary to execute a process based on a determination result. Also, the processing unit 224 causes the cryptographic key control unit 220 to delete a service cryptographic key after use of the service cryptographic key has been completed during execution of a process based on the determination result. Also, the processing unit 224 causes the communication control unit 228 to control communication in the case of relaying communication related to a service between the information processing apparatus 100 and the service providing server 400.

The encryption processing unit 226 plays a role in performing part of the foregoing process (III) (execution of a process). More specifically, the encryption processing unit 226 selectively performs encryption/decryption of information by using a service cryptographic key stored in the first storage unit 204 on the basis of a process performed by the processing unit 224. Also, the encryption processing unit 226 performs various encryption processes in the information processing server 200, such as encryption/decryption (e.g., encryption/decryption using a session key) of information related to communication with an external apparatus, such as the information processing apparatus 100.

The communication control unit 228 plays a role in performing part of the foregoing process (III) (execution of a process). More specifically, the communication control unit 228 controls communication related to a service between the information processing apparatus and the service providing server on the basis of a process performed by the processing unit 224. By being provided with the control unit 208 having the communication control unit 228, the information processing server 200 can play a role in relaying communication related to a service between the information processing apparatus 100 and the service providing server 400, as in step S820 in FIG. 14, for example.

By being provided with the cryptographic key control unit 220, process determining unit 222, processing unit 224, encryption processing unit 226, and communication control unit 228, the control unit 208 can play a leading role in performing the foregoing processes (I) (storage of a service cryptographic key) to (III) (execution of a process).

The operation unit 210 is an operation unit of the information processing server 200 that enables a user to perform an operation. By being provided with the operation unit 210, the information processing server 200 enables an administrator of the server to perform an operation, and can perform a process desired by the administrator in accordance with an operation performed by the administrator. Here, examples of the operation unit 210 include a button, a direction key, a rotary selector such as a jog dial, and a combination of those components.

The display unit 212 is a display unit of the information processing server 200 and displays various pieces of information on its display screen. Examples of a screen displayed on the display screen of the display unit 212 include an application execution screen, a display screen showing a status of communication with an external apparatus, and an operation screen for causing the information processing server 200 to perform a desired operation. Here, examples of the display unit 212 include an LCD and an organic EL display. For example, the display unit 212 of the information processing server 200 may be configured using a touch screen. In that case, the display unit 212 functions as an operation display unit capable of performing both an operation by an administrator and display.

With the configuration illustrated in FIG. 24, the information processing server 200 can perform the foregoing processes (I) (storage of a service cryptographic key) to (III) (execution of a process) related to an approach for increasing convenience. Of course, the configuration of the information processing server according to the embodiment of the present invention is not limited to the configuration illustrated in FIG. 24.

As described above, the information processing system 1000 according to the embodiment of the present invention includes the information processing apparatus 100 and the information processing server 200. The information processing server 200 collectively manages encrypted account information, selectively performs encryption/decryption of account information on the basis of a processing request, service cryptographic key, and identification information transmitted from the information processing apparatus 100, and performs a process related to a service in response to the processing request. On the other hand, the information processing apparatus 100 transmits, to the information processing server 200, a processing request indicating a desired process, a service cryptographic key, and identification information, and performs a process on the basis of information that is transmitted from the information processing server 200 as a result of a process performed in response to the processing request. In the information processing system 1000, the information processing server 200 can collectively manage account information used for enjoying a service provided by the service providing server 400. Thus, it is unnecessary for the information processing apparatus 100 to manage account information. Accordingly, with the information processing server 200, the information processing system 1000 can increase convenience with which a service provided via a network is enjoyed.

In the case of encrypting account information, the information processing server 200 encrypts the account information obtained from the service providing server 400 by using a received service cryptographic key. In the case of decrypting encrypted account information, the information processing server 200 decrypts the encrypted account information associated with identification information by using a received service cryptographic key, thereby obtaining account information. Here, the information processing server 200 stores the received service cryptographic key only temporarily. Thus, even if the encrypted account information that is collectively managed by the information processing server 200 is stolen by a malicious third party, the third party is incapable of decrypting the encrypted account information. Therefore, the information processing system 1000 can prevent abuse of a service by a third party by being provided with the information processing server 200.

Accordingly, with the use of the information processing apparatus 100 and the information processing server 200, abuse of a service can be prevented and convenience with which a service provided via a network is enjoyed can be increased.

Also, in the information processing system 1000, abuse of a service by a third party can be prevented even if the information processing server 200 does not collectively manage account information by storing it in a tamper-resistant recording medium. Of course, the information processing server 200 can store account information in a tamper-resistant recording medium.

A description has been given above about the information processing apparatus 100 serving as an element constituting the information processing system 1000 according to the embodiment of the present invention, but the embodiment of the present invention is not limited to the foregoing embodiment. For example, the embodiment of the present invention can be applied to various apparatuses, such as a computer including a personal computer (PC) and a personal digital assistant (PDA), a mobile communication apparatus including a mobile phone and a personal handyphone system (PHS), a video/audio reproducing apparatus, a video/audio recording and reproducing apparatus, and a portable game machine.

Also, a description has been given above about the information processing server 200 serving as an element constituting the information processing system 1000 according to the embodiment of the present invention, but the embodiment of the present invention is not limited to the foregoing embodiment. For example, the embodiment of the present invention can be applied to various apparatuses, such as a PC and a computer of a server.

### Program According to the Embodiment of the Present Invention Program for Information Processing Apparatus

With a program causing a computer to function as the information processing apparatus according to the embodiment of the present invention, a service can be used via a network while preventing abuse of the service and increasing convenience.

### Program for Information Processing Server

With a program causing a computer to function as the information processing server according to the embodiment of the present invention, abuse of a service can be prevented and convenience with which a service provided via a network is enjoyed can be increased.

An exemplary embodiment of the present invention has been described above with reference to the attached drawings, but the present invention is not limited to the foregoing embodiment. It is obvious that those skilled in the art can achieve various changes and modifications within the scope of the appended claims, and those changes and modifications are naturally included in the technical scope of the present invention.

For example, in the information processing apparatus 100 illustrated in FIG. 22, the control unit 106 includes the communication control unit 120, the processing unit 122, and the encryption processing unit 124, but the information processing apparatus according to the embodiment of the present invention may have another configuration. For example, the information processing apparatus according to the embodiment of the present invention may include the communication control unit 120, the processing unit 122, and the encryption processing unit 124 illustrated in FIG. 22 separately (e.g., the individual units may be realized by separate processing circuits).

On the other hand, in the information processing server 200 illustrated in FIG. 24, the control unit 208 includes the cryptographic key control unit 220, the process determining unit 222, the processing unit 224, the encryption processing unit 226, and the communication control unit 228, but the information processing server according to the embodiment of the present invention may have another configuration. For example, the information processing server according to the embodiment of the present invention may include the cryptographic key control unit 220, the process determining unit 222, the processing unit 224, the encryption processing unit 226, and the communication control unit 228 illustrated in FIG. 24 separately (e.g., the individual units may be realized by separate processing circuits).

Furthermore, according to the description given above, there are provided programs (computer programs) causing a computer to function as the information processing apparatus and the information processing server according to the embodiment of the present invention. The embodiment of the present invention can also provide a storage medium storing the programs.

It should be understood by those skilled in the art that various modifications, combinations, sub-combinations and alterations may occur depending on design requirements and other factors insofar as they are within the scope of the appended claims or the equivalents thereof.

What is claimed is:

1. An information processing server, comprising:
a communication unit configured to receive from an information processing apparatus a processing request and a cryptographic key corresponding to the processing request;
a first storage unit configured to temporarily store the cryptographic key received by the communication unit;
a second storage unit configured to store data;
a process determining unit configured to determine a type of process requested based on the processing request;
an encryption processing unit configured to selectively perform, based on the determined type of process requested, at least one of encryption or decryption on the data stored in the second storage unit using the cryptographic key; and
a cryptographic key control unit configured to delete the cryptographic key temporarily stored in the first storage unit after the at least one of encryption or decryption on the data stored in the second storage unit has been selectively performed by the encryption processing unit.

2. The information processing server according to claim 1, wherein
the process determining unit, the encryption processing unit, and the cryptographic key control unit are included in a single control unit.

3. The information processing server according to claim 1, wherein
the second storage unit is configured to store a plurality of encrypted data associated with a plurality of different information processing apparatuses, the plurality of encrypted data being encrypted using different cryptographic keys.

4. The information processing server according to claim 3, wherein
the communication unit is configured to receive identification information indicating the information processing apparatus that transmitted the processing request; and
when the encryption processing unit performs the decryption based on the determined type of process requested, the encryption processing unit decrypts the encrypted data associated with the one of the plurality of different information processing apparatuses corresponding to the identification information using the cryptographic key.

5. The information processing server according to claim 1, wherein
the communication unit is configured to receive identification information indicating the information processing apparatus that transmitted the processing request, and
when the encryption processing unit performs the encryption based on the determined type of process requested, the encryption processing unit encrypts the data and stores the encrypted data in the second storage unit in association with the identification information.

6. The information processing server according to claim 1, wherein
the communication unit is configured to relay communications related to a service between the information processing apparatus and a service providing server.

7. The information processing server according to claim 1, wherein
the encryption processing unit is configured to only use the temporarily stored cryptographic key once to selectively perform, based on the determined type of process requested, the at least one of encryption or decryption on the data stored in the second storage unit, before the temporarily stored cryptographic key is deleted by the cryptographic key control unit.

8. The information processing server according to claim 1, wherein
the second storage unit is configured to store encrypted account information for accessing a service provided by a service providing server; and
when the process determining unit determines that the type of process requested is a service login request,
the encryption processing unit decrypts the encrypted account information for accessing the service, corresponding to the service login request, stored in the second storage unit using the cryptographic key; and
the communication unit transmits the decrypted account information to the service providing server.

9. The information processing server according to claim 1, wherein
when the process determining unit determines the type of process requested includes requesting account information from an external apparatus,
the communication unit is configured to transmit a request for the account information to the external apparatus, and to receive the account information from the external apparatus, and
the encryption processing unit is configured to encrypt the account information received from the external apparatus using the cryptographic key temporarily stored in the first storage unit.

10. An information processing server, comprising:
means for receiving from an information processing apparatus a processing request and a cryptographic key corresponding to the processing request;
means for temporarily storing the cryptographic key received by the means for receiving;
means for storing data;
means for determining a type of process requested based on the processing request;
means for selectively performing, based on the determined type of process requested, at least one of encryption or decryption on the data stored in the means for storing using the cryptographic key; and
means for deleting the cryptographic key temporarily stored in the means for temporarily storing after the at least one of encryption or decryption on the data stored in the means for storing has been selectively performed by the means for selectively performing.

11. A method of using an information processing server for selectively performing at least one of encryption or decryption on data, comprising:
receiving from an information processing apparatus a processing request and a cryptographic key corresponding to the processing request;
temporarily storing the received cryptographic key;
determining, by the information processing server, a type of process requested based on the processing request;
selectively performing, by the information processing server, based on the determined type of process requested, the at least one of encryption or decryption on the data stored in the information processing server using the cryptographic key; and
deleting the temporarily stored cryptographic key after the at least one of encryption or decryption on the data stored in the information processing server has been selectively performed in the selectively performing step.

12. A non-transitory computer-readable storage medium having embedded therein instructions, which when executed by a processor, cause the processor to perform a method for selectively performing at least one of encryption or decryption on data, comprising:
receiving from an information processing apparatus a processing request and a cryptographic key corresponding to the processing request;
temporarily storing the received cryptographic key;
determining a type of process requested based on the processing request;
selectively performing, based on the determined type of process requested, the at least one of encryption or decryption on the data stored in the information processing server using the cryptographic key; and
deleting the temporarily stored cryptographic key after the at least one of encryption or decryption on the data stored in the information processing server has been selectively performed in the selectively performing step.

13. An information processing apparatus, comprising:
a storage unit configured to store at least one cryptographic key for at least one of encryption or decryption;
a communication unit configured to send a processing request to an information processing server, and to send a stored cryptographic key corresponding to the processing request to the information processing server based on whether the processing request requires the information processing server to perform the at least one of encryption or decryption on data stored in the information processing server, wherein
the communication unit sends the stored cryptographic key to the information processing server when the processing request sent by the communication unit requires the information processing server to perform the at least one of encryption or decryption on the data stored in the information processing server.

14. The information processing apparatus according to claim 13, further comprising:
a processing unit configured to generate the processing request.

15. The information processing apparatus according to claim 13, wherein
the communication unit sends the stored cryptographic key to the information processing server each time the processing request sent by the communication unit requires the information processing server to perform the at least one of encryption or decryption on the data stored in the information processing server.

16. The information processing apparatus according to claim 13, further comprising:
an encryption processing unit configured to generate the at least one cryptographic key for the at least one of the encryption or decryption.

17. A method of using an information processing apparatus for requesting an information processing server to perform a process, the method comprising:
storing at least one cryptographic key for at least one of encryption or decryption;
sending, by the information processing apparatus, a processing request and a stored cryptographic key corresponding to the processing request to the information processing server based on whether the processing request requires the information processing server to perform the at least one of encryption or decryption on data stored in the information processing server, wherein
the sending step includes sending the stored cryptographic key to the information processing server when the processing request requires the information processing server to perform the at least one of encryption or decryption on the data stored in the information processing server.

18. A non-transitory computer-readable storage medium having embedded therein instructions, which when executed by a processor, cause the processor to perform a method for requesting an information processing server to perform a process, the method comprising:
storing at least one cryptographic key for at least one of encryption or decryption;
sending a processing request and a stored cryptographic key corresponding to the processing request to the information processing server based on whether the processing request requires the information processing server to perform the at least one of encryption or decryption on data stored in the information processing server, wherein
the sending step includes sending the stored cryptographic key to the information processing server when the processing request requires the information processing server to perform the at least one of encryption or decryption on the data stored in the information processing server.

19. An information processing system, comprising:
an information processing apparatus, including
a first storage unit configured to store at least one cryptographic key for at least one of encryption or decryption, and
a first communication unit configured to send a processing request to an information processing server, and to send a stored cryptographic key corresponding to the processing request to the information processing server based on whether the processing request requires the information processing server to perform the at least one of encryption or decryption on data stored in the information processing server; and
the information processing server, including
a second communication unit configured to receive from the information processing apparatus the processing request and the cryptographic key corresponding to the processing request,
a second storage unit configured to temporarily store the cryptographic key received by the second communication unit,
a third storage unit configured to store the data;
a process determining unit configured to determine a type of process requested based on the processing request,
an encryption processing unit configured to selectively perform, based on the determined type of process requested, the at least one of encryption or decryption on the data stored in the third storage unit using the cryptographic key, and
a cryptographic key control unit configured to delete the cryptographic key temporarily stored in the second storage unit after the at least one of encryption or decryption on the data stored in the third storage unit has been selectively performed by the encryption processing unit.

20. A method of using an information processing system, including an information processing apparatus and an information processing server, for selectively performing at least one of encryption or decryption on data, comprising:
storing at least one cryptographic key for the at least one of encryption or decryption;
sending, by the information processing apparatus, a processing request and a stored cryptographic key corresponding to the processing request to the information processing server based on whether the processing request requires the information processing server to perform the at least one of encryption or decryption on the data stored in the information processing server;
receiving, by the information processing server, the processing request and the cryptographic key corresponding to the processing request;
temporarily storing, by the information processing server, the received cryptographic key;
determining, by the information processing server, a type of process requested based on the processing request;
selectively performing, by the information processing server, based on the determined type of process requested, the at least one of encryption or decryption on the data stored in the information processing server using the cryptographic key; and
deleting the temporarily stored cryptographic key after the at least one of encryption or decryption on the data stored in the information processing server has been selectively performed in the selectively performing step.
